(19) United States
(12) Patent Application Publication
(10) Pub. No.: US 2016/0209565 A1
(43) Pub. Date: Jul. 21, 2016

(54) POLARIZING PLATE AND LIQUID CRYSTAL DISPLAY DEVICE

(71) Applicant: FUJIFILM Corporation, Tokyo (JP)

(72) Inventors: Masato NAKAO, Kanagawa (JP); Yoshiaki HISAKADO, Kanagawa (JP)

(73) Assignee: FUJIFILM Corporation, Tokyo (JP)

(21) Appl. No.: 15/000,256

(22) Filed: Jan. 19, 2016

(30) Foreign Application Priority Data
Jan. 19, 2015 (JP) 2015-007876

(51) Int. Cl. G02B 5/30; G02F 1/1335

(52) U.S. Cl. CPC G02B 5/305; G02F 1/133528

(57) ABSTRACT

There is provided a polarizing plate including a transparent support, a polarizer, and a low-moisture permeable layer in this order, wherein a thickness of the polarizer is 15 μm or less, a film thickness of the low-moisture permeable layer is greater than 5 μm and equal to 30 μm or less, the low-moisture permeable layer is formed from a composition containing at least one of a compound having a cyclic aliphatic hydrocarbon group and two or more ethylenically unsaturated double bond groups in its molecule, and a compound having a fluorene ring and two or more ethylenically unsaturated double bond group in its molecule, and a polymerization initiator, and the polarizer and the low-moisture permeable layer are laminated directly or through an adhesive layer.

### CROSS REFERENCE TO RELATED APPLICATION(S)

This application claims priority from Japanese Patent Application No. 2015-007876 filed on Jan. 19, 2015, the entire disclosures of which are incorporated herein by reference.

### BACKGROUND

1. Technical Field

The present invention relates to a polarizing plate and a liquid crystal display device.

2. Background Art

In recent years, a liquid crystal display device has been widely used in applications such as a television, a personal computer, a mobile phone, and a digital camera. In general, the liquid crystal display device has a liquid crystal panel member in which polarizing plates are provided at both sides (a viewing side and a backlight side) of a liquid crystal cell, and performs a display by controlling a light from a backlight member by the liquid crystal panel member.

Recent liquid crystal display devices have been diversified in use along with high quality, and the requirements for durability have become stricter. For example, for outdoor use, it is required to maintain stability in response to an environmental change. As for the polarizing plate used in a liquid crystal display device, it is also required to suppress dimensional or optical characteristics from changing in response to a change in temperature or moisture.

In general, the polarizing plate is configured by including a polarizer and a film that protects it (a polarizing plate protective film).

For example, Japanese Patent Laid-Open Publication No. 2005-345958 (hereinafter, referred to as JP-A-2005-345958) discloses a polarizing plate in which a polyethylene terephthalate film or a cyclic olefin-based resin film having low moisture permeability is attached at a viewing side of a polarizer in a viewing side polarizing plate.

Further, Japanese Patent Laid-Open Publication No. 2011-93133 (hereinafter, referred to as JP-A-2011-93133) discloses that a hard coat film formed by laminating a hard coat layer is disposed on a transparent support composed of triacetyl cellulose, on a display side surface.

However, for small and medium-sized appliances, such as recently rapidly spreading tablet PCs or mobiles, there has been a high demand for thinner films or space savings in liquid crystal display devices.

This demad has been reviewed to make the polarizing plate thinner.

With thinning of the polarizing plate, thinning of the polarizing plate protective film has been considered. Accordingly, since the moisture permeability of the polarizing plate protective film is increased, the polarizer of the polarizing plate becomes more susceptible to the change in temperature or moisture. Therefore, even in a case of a thinn film thickness, it is demanded to enhance a moisture-heat durability of the polarizer (also referred to as a polarizer durability).

As a means to improve the polarizer durability, as in JP-A-2005-345958, a review has been made to fabricate a polarizing plate using a synthesized polymer film such as a polyethylene terephthalate film or a cyclic olefin-based resin film, as a polarizing plate protective film.

However, the polarizing plate protective film disclosed in JP-A-2005-345958 is a film having a film thickness of around 80 μm, and when the film is made thinner, the low-permeability may not be sufficiently obtained in some cases.

Further, the polarizing plate protective film using the synthesized film may not have sufficient adhesion when a hoard coat layer is coated on the surface of the synthesized polymer film, and there is a problem in that the use for the outermost surface of the viewing side is limited. Further, the eyelid olefin-based film needs to he bonded to the polarizer using a UV-curable adhesive due to the lack of adhesion with the polarizer.

Meanwihile, in the hard coat film formed by laminating the hard coat layer on the transparent support composed of triacetyl cellulose, disclosed in JP-A-2011-93133, the transparent support has a thick film thickness of 80 μm, and the hard coat film has high moisture permeability.

In consideration of the aforementioned circumstance, an object of the present invention, that is, a means to solve the problem is to provide a polarizing plate which is thin, has low moisture permeability, is excellent in polarizer durability, and, when funning a hard coat layer, is excellent from the viewpoints of adhesion with the hard coat layer and brittleness of the hard coat layer. Further, another object of the present invention is to provide a liquid crystal display device which can suppress display unevenness from occurring over time under a high-temperature and high-moisture condition, using the polarizing plate.

The inventors of the present invention have intensitively studied, and as a result, found that since a thin polarizing plate is realized, while maintaining low moisture permeability, by forming a thin low-moisture permeable layer containing a compound having a specific structure on one surface of a thin polarize directly or through an adhesion, it is possible to obtain a polarizing plate which has high polarizer durability, and, when forming a hard coat layer, is excellent from the viewpoints of adhesion with the hard coat layer and brittleness of the hard coat layer. Further, it is found that a liquid crystal display device, which can suppress display unevenness from occurring over time under a high-temperature and high-moisture condition, may be provided using the polarizing plate, thereby achieving the present invention.

### SUMMARY

The object to be solved by the present invention can be solved by the following means.

<1> A polarizing plate including a transparent support, a polarizer, and a low-moisture permeable layer in this order,

wherein a thickness of the polarizer is 15 μm or less,

a film thickness of the low-moisture permeable layer is greater than 5 μm and 30 μm or less,

the low-moisture permeable layer is formed from a composition containing at least one of a compound having a cyclic aliphatic hydrocarbon group and two or more ethylenically unsaturated double bond groups in its molecule, and a compound having a fluorene ring and two or more ethylenically unsaturated double bond group in its molecule, and a polymerization initiator, and

the polarizer and the low-moisture permeable layer are laminated directly or through an adhesive layer.

<2> The polarizing plate of <1>, wherein a hard coat layer is provided on a surface opposite to the polarizer of the low-moisture permeable layer.

<3> The polarizing plate of <1>, wherein the cyclic aliphatic hydrocarbon group is a group represented by the following Formula (I):

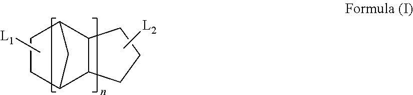

wherein L₁ and L₂ each independently represent a single bond or di- or higher-valent group, and

n represents an integer of 1 to 3.

<4> The polarizing plate of <1>, wherein the composition contains a rosin compound.

<5> The polarizing plate of <1>, wherein the transparent support contains a polymer selected from a cellulose acylate-based polymer, a polyester-based polymer, a (meth)acrylic polymer, and a cycloolefin-based polymer in an amount of 50% by mass or more in the transparent support.

<6> The polarizing plate of <1>, wherein a thickness of the transparent support is 35 μm.

<7> The polarizing plate of <1>, wherein a thickness of the polarizing plate is 80 μm or less.

<8> The polarizing plate of <1>, wherein the low-moisture permeable layer has an ultraviolet absorbability.

<9> A liquid crystal display device including:

a liquid crystal cell; and

the polarizing plate of <1> which is disposed at a viewing side of the liquid crystal cell,

wherein the low-moisture permeable layer of the polarizing plate is arranged at the viewing side.

According to the present invention, it is possible to provide a polarizing plate which is thin, has low moisture permeability, is excellent in polarizer durability, and, when forming a hard coat layer, is excellent from the viewpoints of adhesion with the hard coat layer and brittleness of the hard coat layer. Further, it is possible to provide a liquid crystal display device which can suppress display unevenness from occurring over time under a high-temperature and high-moisture condition, using the polarizing plate.

### DETAILED DESCRIPTION OF EXEMPLARY EMBODIMENTS

Hereinafter, the polarizing plate and the liquid crystal display device of to the present invention will be described in detail.

The compositional requirements for the invention may be described below based on representative embodiments of the present invention, but the present invention is not limited thereto. Also, a numerical range represented using the dash “to” means a range having the numerical values coming before and after “to” as the lower limiting value and the upper limiting value, respectively.

The term “solid” means a component except the solvent in the curing composition.

The term “acrylic resin” is used to mean a resin obtained by polymerizing a derivative from a methacrylic acid or an acrylic acid and a resin containing the derivative. Unless otherwise specifically defined, the term “(meth)acrylate” refers to acrylate and methacrylate, and the term “(meth)acryl” refers to acryl and methacryl.

Also, the “slow axis direction” of the film means an in-plane direction in which the refractive index reaches the maximum value, and the “fast axis direction” means an in-plane direction orthogonal to the slow axis.

[Polarizing Plate]

The polarizing plate of the present invention is a polarizing plate including a transparent support, a polarizer, and a low-moisture permeable layer in this order,

in which a thickness of the polarizer is 15 μm or less,

a film thickness of the low-moisture permeable layer is greater than 5 μm and equal to 30 μm or less,

the low-moisture permeable layer is formed from a composition containing at least one of a compound having a cyclic aliphatic hydrocarbon group and two or more ethylenically unsaturated double bond groups in its molecule, and a compound having a fluorene ring and two or more ethylenically unsaturated double bond group, and a polymerization initiator, and

the polarizer and the low-moisture permeable layer are laminated directly or through an adhesive layer.

Hereinafter, descriptions will be made on the low-moisture permeable layer included in the polarizing plate.

{Low-Moisture Permeable Layer}

The low-moisture permeable layer included in the polarizing plate of the present invention is formed from a composition (a low-moisture permeable layer forming composition) containing at least one of a compound having a cyclic aliphatic hydrocarbon group and two or more ethylenically unsaturated double bond groups in its molecule, and a compound having a fluorene ring and two or more ethylenically unsaturated double bond group, and a polymerization initiator. The layer may be formed by additionally coating, drying, and curing a curable composition containing a rosin compound, light-transmitting particles, a fluorine-containing or silicone-based compound, and a solvent, on the transparent support directly or through an adhesive layer. Hereinafter, the components of the low-moisture permeable layer will be described.

[(A) At least one of a compound having a cyclic aliphatic hydrocarbon group and two or more ethylenically unsaturated double bond groups in its molecule, and a compound having a fluorene ring and two or more ethylenically unsaturated double bond group]

Hereinafter, the aforementioned (A) is also referred to as Component (A).

Component (A) may be a compound having a cyclic aliphatic hydrocarbon group and two or more ethylenically unsaturated double bond groups in its molecule, may be a compound having a fluorene ring and two or more ethylenically unsaturated double bond group, or may include both.

Component (A) may function as a binder.

When Component (A) is used, it is possible to realize the low moisture permeability, to enhance the adhesion with the low moisture permeable layer, and to improve the polarizer durability. Although the details are not clear, as the compound having a cyclic aliphatic hydrocarbon group and two or more ethylenically unsaturated double bond groups in its molecule is used, a hydrophobic cyclic aliphatic hydrocarbon group is introduced into the low-moisture permeable layer, which is in turn hydrophobicized, thereby preventing uptake of molecules from the outside, so that the moisture permeability is reduced. Further, as the compound has two or more ethylenically unsaturated double bond groups in its molecule, a crosslinking point density is increased, thereby limiting a diffusion path of water molecules in the low-moisture permeable layer. It is considered tha the increase in crosslinking point density has a function to relatively increase the density of the cyclic aliphatic hydrocarbon group, and the inside of the low-moisture permeable layer is further hydrophobicized, thereby preventing adsorption of water molecules and decreasing the moisture penneability.

Component (A) is preferably a compound having a cyclic aliphatic hydrocarbon group and two or more ethylenically unsaturated double bond groups in its molecule, and more preferably a compound having a cyclic aliphatic hydrocarbon group and two ethylenically unsaturated double bond groups in its molecule.

The cyclic aliphatic hydrocarbon group is preferably a group derived from an alicyclic compound having 7 or more carbon atoms, more preferably a group derived from an alicyclic compound having 10 or more carbon atoms, and still more preferably a group derived from an alicyclic compound having 12 or more carbon atoms.

The cyclic aliphatic hydrocarbon group is particularly preferably a group derived from a polycyclic compound, such as a bicyclic compound or a tricyclic compound.

The central skeleton of the compounds described in the claims of Japanese Patent Laid-Open Publication No. 2006-215096, the central skeleton of the compounds described in Japanese Patent Laid-Open Publication No. 2001-10999, the skeleton of an adamantane derivative, and the like are more preferred.

Specific examples of the cyclic aliphatic hydrocarbon group may include a norbornane group, a tricyciodecane group, a tetracyclododecane group, a pentacyclopentadecane group, an adamantane group, and a di-adamantane group.

The cyclic aliphatic hydrocarbon group (including a linking group) is preferably a group represented by any of the following Formulas (I) to (V), more preferably a group represented by the following Formula (I), (II) or (IV), still more preferably a group represented by the following Formula (I) or (IV), and particularly preferably a group represented by the following Formula (I).

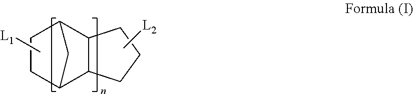

In Formula (I), L₁ and L₂ each independently represent a single bond or a di- or higher-valent linking group. n represents an integer of 1 to 3.

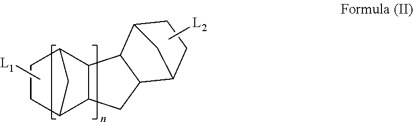

In Formula (II), L₁ and L₂ each independently represent a single bond or a di- or higher-valent linking group. n represents an integer of 1 to 2.

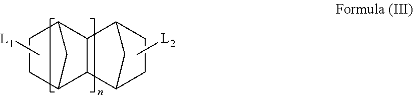

In Formula (III), L₁ and L₂ each independently represent a single bond or a di- or higher-valent linking group. n represents an integer of 1 to 2.

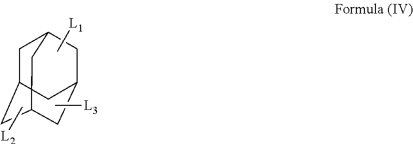

In Formula (IV), L₁ and L₂ each independently represent a single bond or a di- or higher-valent linking group, and L₃ represents a hydrogen atom, a single bond, or a di- or higher-valent group.

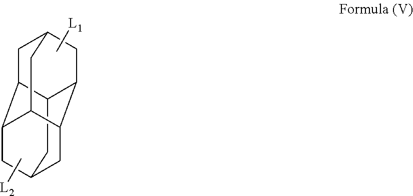

In Formula (V), L₁ and L₂ each independently represent a single bond or a di- or higher-valent linking group.

Examples of the di- or higher-valent linking group for L₁, L₂, and L₃ may include an alkylene group having 1 to 6 carbon atoms which may be substituted, an amid bond which may be substituted at the N-position, a urethane bond which may be substituted at the N-position, an ester bond, an oxycarbonyl group, and an ether bond, and a group obtained by combining two or more thereof.

Examples of the enthylenically unsaturated double bond in Component (A) may include a polymerizable functional group, such as a (meth)acryloyl group, a vinyl group, a styryl group, and an allyl group. Among those, a (meth)acryloyl group and —C(O)OCH═CH₂ are preferred.

The compound having a cyclic aliphatic hydrocarbon group and two or more ethylenically unsaturated double bond groups in its molecule is formed by bonding the cyclic aliphatic hydrocarbon group and the group having an ethylenically unsaturated double bond group via a linking group.

These compounds may be readily synthesized by a single-step or two-step reaction of polyol having the above-described cyclic aliphatic hydrocarbon group, such as diol and triol, with a carboxylic acid of a compound having a (meth)acryloyl group, a vinyl group, a styryl group, or an allyl group, a carboxylic derivative, an epoxy derivative, or an isocyanate derivative.

Preferably, the synthesis may be performed by reacting a compound, such as (meth)acrylic acid, (meth)acryloyl chloride, (meth)acrylic anhydride, or (meth)acrylic glycydyl, or a compound described in WO 2012/00316A (e.g., 1,1-bis(acryloxymethyl)ethyl isocyanate) with polyol having the above-described cycloaliphatic hydrocarbon group.

In the following, preferred specific examples of Component (A) will be represented, but the present invention is not limited thereto.

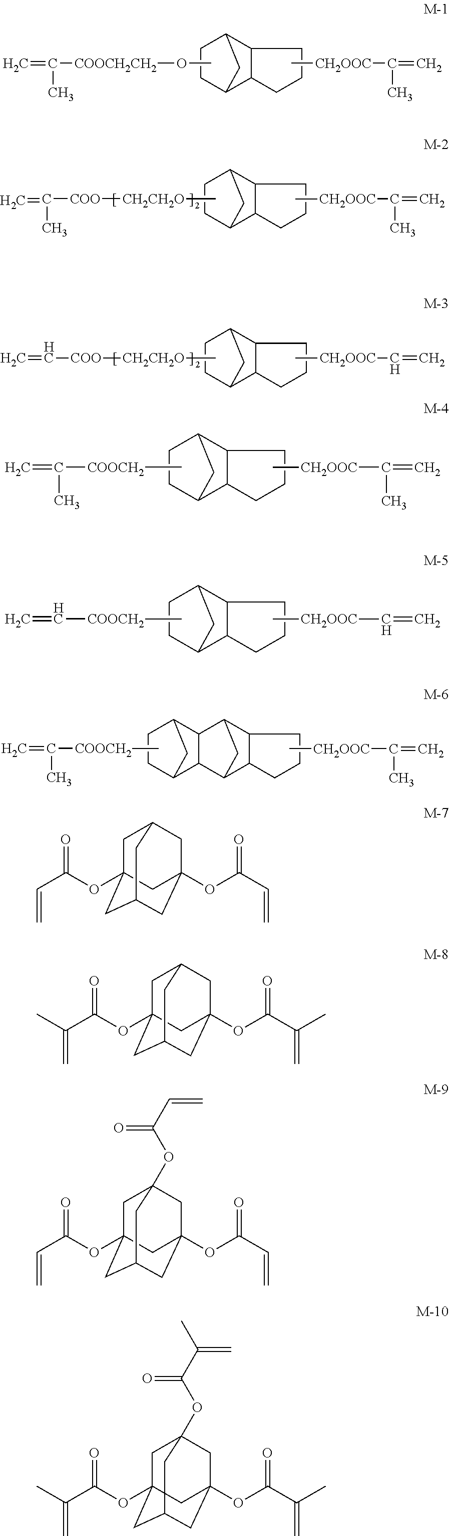

[Compound having a fluorene ring and two or more ethylenically unsaturated double bond groups in its molecule]

The compound having a fluorene ring and two or more ethylenically unsaturated double bond groups in its molecule may function as a binder. In addition, the compound having a fluorene ring and two or more ethylenically unsaturated double bond groups in its molecule may function as a curing agent and is able to improve the strength or scratch resistance of a coated film and impart low moisture permeability.

The compound having a fluorene ring and two or more ethylenically unsaturated double bond groups in its molecule is preferably represented by Formula (VI).

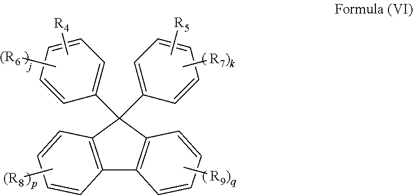

In Formula (VI), R₄, R₅, R₆, R₇, R₈, and R₉ each independently represent a monovalent substituent, j, k, p and q each independently represent an integer of 0 to 4, and R₄ and R₅ represent a monovalent organic group having an ethylenically unsaturated double bond.

A preferred embodiment of Formula (VI) as a compound having a fluorene skeleton and two or more ethylenically unsaturated double bond groups in its molecule is represented by the following Formula (VII).

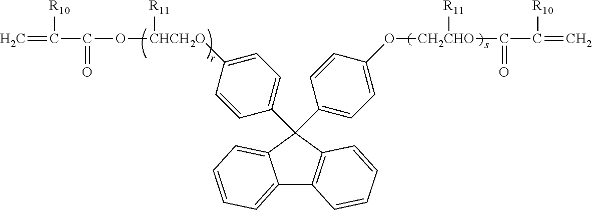

In Formula (VII), R₁₀ and R₁₁ each independently represent a hydrogen atom or a methyl group, and r and s each independently represent an integer of 0 to 5.

Assuming that the total solid content of the low-moisture permeable layer forming composition is 100% by mass, the content of Component (A) is preferably 50% by mas to 99% by mass, and from the viewpoint of remarkability of reduction in the moisture permeability, more preferably greater than 50% by mass and equal to 97% by mass or less, still more preferably greater than 50% by mass and equal to 82% by mass or less, and particularly preferably greater than 50% by mass and equal to 77% by mass or less.

[Compound having an ethylenically unsaturated double bond but having neither a cycloaliphatic hydrocarbon group nor a fluorene ring]

In the low-moisture permeable layer forming composition used in the present invention, a compound having an ethylenically unsaturated double bond but having neither a cycloaliphatic hydrocarbon group nor a fluorene ring in its molecule may be used together within a range that does adversely affect the present invention.

The compound having an ethylenically unsaturated double bond but free of a cycloaliphatic hydrocarbon group and a fluorene ring is preferably a (meth)acrylate compound free of a cycloaliphatic hydrocarbon group and a fluorene ring. Examples thereof may include (meth)acrylic acid diesters of alkylenc glycol, (meth)acrylic acid diesters of polyoxyalkylene glycol, (meth)acrylic acid diesters of polyhydric alcohol, (meth)acrylic acid diesters of ethylene oxide or propylene oxide adduct, epoxy (meth)acrylates, urethane (meth)acrylates, and polyester (meth)acrylates.

Among those, esters of polyhydric alcohol and (meth)acrylic acid are preferred. Examples thereof may include 1,4-butanediol di(meth)acrylate, 1,6-hexanediol di(meth)acrylate, neopentyl glycol(meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified triphosphate(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, polyurethane polyacrylate, polyester polyacrylate, and caprolactone-modified tris(acryloxyethyl)isocyanurate.

Polyfunctional acrylate-based compounds having a (meth)acryloyl group may be commercially available, and examples thereof may include NK Ester A-TMMT manufactured by Shin-Nakamura Chemical Co., Ltd. and KAYARAD DPHA manufactured by Nippon Kayaku Co., Ltd. As for polyfunctional monomers, those described in paragraphs [0114] to [0122] of Japanese Patent Laid-Open Publication No. 2009-98658 may also be used in the present invention.

The compound having an ethylenically unsaturated double bond but free of a cycloaliphatic hydrocarbon group may preferably be a compound having a hydrogen-bondable substituent from the viewpoint of the adhesion to a support and the low curling. The hydrogen-bondable substituent refers to a substituent in which atoms such as nitrogen, oxygen, sulfur, or halogen are covalently bonded to hydrogen. Specific examples thereof may include —OH, —SH, —NH—, —CHO, —CONH—, —OCONH—, etc., and urethane(meth)acrylates or (meth)acrylates having a hydroxyl group are preferred. Polyfunctional acrylate having a commercially available (meth)acryloyl group may be used, and examples thereof may include NK Oligo U4HA and NK Ester A-TMM-3 manufactured by Shin-Nakamura Chemical Co., Ltd., and KAYARAD PET-30 manufactured by Nippon Kayaku Co., Ltd.

When the compound having an ethylenically unsaturated double bond but free of a cycloaliphatic hydrocarbon and a fluorene ring is contained, its content is preferably 1% by mass to 30% by mass, more preferably 2% by mass to 20% by mass, and still more preferably 3% by mass to 15% by mass, based on the total solid content when the total solid content of a low-moisture permeable layer-forming curable composition is assumed to 100% by mass.

[Polymerization Initiator]

The low-moisture permeable layer included in the polarizing plate of the present invention. preferably contains a polymerization initiator as well as Component (A) that contains at least one of a compound having a cyclic aliphatic hydrocarbon group and two or more ethylenically unsaturated double bond groups in its molecule, and a compound having a fluorene ring and two or more ethylenically unsaturated double bond group. The polymerization initiator is preferably a photopolymerization initiator.

Examples of the photopolymerization initiator include acetophenones, benzoins, benzophenones, phosphine oxides, ketals, anthraquinones, thioxanthones, azo compounds, peroxides, 2,3-dialkyl-dione compounds, disulfide compounds, fluoroamine compounds, aromatic sulfonium, lophine dimers, onium salts, borate salts, active esters, active halogens, inorganic complexes, and coumarins. Specific examples, preferred embodiments and commercially available products of the photopolymerization initiator are described in paragraphs [0133] to [0151] of Japanese Patent Laid-Open Publication No. 2009-098658, and may also be suitably used in the present invention.

Various examples are also described in Kiyomi Kato, “Latest UV Curing Technology” (Technical Information Institute Co., Ltd.) (1991), p. 159, and “UV Curing System,” (Kabushikikaisha Sogo Gijutsu Center, 1989), pp. 65-148, and those are useful for the present invention.

Preferred examples of a commercially available photocleavage type photoradical polymerization initiator may include “Irgacure 651,” “Irgacure 184,” “Irgacure 819,” “Irgacure 907,” “Irgacure 1870” (CGI-403/Irgacure 184=a 7/3 mixed initiator), “Irgacure 500,” “Irgacure 369,” “Irgacure 1173,” “Irgacure 2959,” “Irgacure 4265,” “Irgacure 4263,” “Irgacure 127,” “OXE01” and the like, manufactured by BASF; “Kayacure DETX-S,” “Kayacure BP-100,” “Kayacure BDMK,” “Kayacure CTX,” “Kayacure BMS,” “Kayacure 2-EAQ,” “Kayacure ABQ,” “Kayacure CPTX,” “Kayacure EPD,” “Kayacure ITX,” “Kayacure QTX,” “Kayacure BTC,” “Kayacure MCA” and the like, manufactured by Nippon Kayaku Co.; “Esacure (KIP100F, KB1, EB3, BP, X33, KTO46, KT37, KIP150, TZT)” and the like, manufactured by Sartomer Company, Inc.”, and combinations thereof.

The content of the photopolymerization initiator in the composition forming the low-moisture permeable layer is preferably 0.5% by mass to 8% by mass, and more preferably 1% by mass to 5% by mass based on the total solid content of the composition, from the viewpoint of determining the content such that a polymerizable compound contained in the composition is polymerized while the starting point is suppressed from excessively increasing.

<Rosin Compound>

In the present invention, a rosin compound is also preferably contained in the low-moisture permeable layer forming composition. When the rosin compound is contained, the moisture permeability may be further reduced.

The rosin compound is preferably at least one selected from rosin, HS (also referred to as a hydrogenated rosin), and an acid-modified rosin, and an esterified rosin (also referred to as rosin ester).

Examples of the rosin may include unmodified rosin, such as tall oil rosin, gum rosin, and wood rosin, having resin acid as a main component, including abietic acid, levopimaric acid, palustric acid, neoabietic acid, dehydroabietic acid, and dihydroabietic acid.

The hydrogenated rosin refers to a hydrogenated one among the above-listed types of rosin. Examples thereof may include those with a high content (for example, 50% by mass or greater) of tetrahedro moiety of, for example, tetrahydroabietic acid. Examples of acid-modified rosin include unsaturated acid-modified rosin obtained by adding an unsaturated acid, such as a maleic acid, a fumaric acid, or an acrylic acid, by Diels-Alder reaction. More specific examples thereof may include a maleopimaric acid obtained by adding a maleic acid to rosin, a fumaropimaric acid obtained by adding a fumaric acid to rosin, and an acrylopimaric acid obtained by adding an acrylic acid to rosin. Examples of the esterified rosin may include alkyl esters of rosin, glycerol ester obtained by esterification of rosin and glycerin, and pentaerythritol esters obtained by esterification of rosin and pentaerythritol.

Examples of the rosin ester may include Super Ester E-720, Super Ester E-730-55, Super Ester E-650, Super Ester E-786-60, Tamanol E-100, Emulsion AM-1002, Emulsion SE-50 (all trade names of special rosin ester emulsions manufactured by Arakawa Chemical Industries, Ltd.), Super Ester L. Super Ester A-18, Super Ester A-75, Super Ester A-100, Super Ester A-115, Super Ester A-125, and Super Ester T-125 (all trade names of special rosin esters manufactured by Arakawa Chemical Industries, Ltd.)

In addition, examples of rosin ester include Ester gum AAG, Ester gum AAL, Ester gum A, Ester gum AAV, Ester gum 105. Ester gum HS, Ester gum AT, Ester gum H, Ester gum HP, Ester gum HD, Pensel A, Pensel AD, Pensel AZ, Pensel C. Pensel D-125, Pensel D-135, Pensel D-160, and Pensel KK (all trade names of rosin ester resins manufactured by Arakawa Chemical Industries, Ltd.)

Examples of other rosin may include RONDIS R, RONDIS K-25, RONDIS K-80, RONDIS K-18 (all trade names of rosin derivatives manufactured by Arakawa Chemical Industries, Ltd.), PINECRYSTAL KR-85, PINECRYSTAL KR-120, PINECRYSTAL KR-612, PINECRYSTAL KR-614, PINECRYSTAL KE-100, PINECRYSTAL KE-311, PINECRYSTAL KE-359, PINECRYSTAL KE-604, PINECRYSTAL 30PX, PINECRYSTAL D-6011, PINECRYSTAL D-6154, PINECRYSTAL D-6240, PINECRYSTAL KM-1500, and PINECRYSTAL KM-1550 (all trade names of super-light-colored rosin derivatives manufactured by Arakawa Chemical Industries, Ltd.), Aradime R-140, Aradime R-95 (all trade names of polymerized rosins manufactured by Arakawa Chemical Industries, Ltd.), Hypale CH (trade name of hydrogenated rosin manufactured by Arakawa Chemical Industries, Ltd.), and Beamset 101 (trade name of rosin acrylate manufactured by Arakawa Chemical Industries, Ltd.).

Further, the rosin compound used in in the present invention is preferably rosin that is subjected to hydrogenation after acid modification. As a result of the hydrogenation, a residual double bond in the rosin compound is oxidized in the low-moisture permeable layer, thereby suppressing the coloring of the film.

The softening point of the rosin compound is preferably 70° C. to 170° C. When the softening point of the rosin compound is 70° C. or higher, the cured layer has an excellent blocking property without being softened. If the softening point is 170° C. or lower, it is possible to maintain solubility in a solvent, thereby making the haze of the cured layer difficult to rise. The softening point of the rosin compound in the present invention can be measured by a ring and ball method described in JIS K-2531.

Further, the acid number of the rosin compound is preferably 150 mgKOH/g to 400 mgKOH/g, more preferably 200 mgKOH/g to 400 mgKOH/g, and particularly preferably 280 mgKOH/g to 400 mgKOH/g, from the viewpoint of both the reduction in moisture permeability and the brittleness improvement effect. The acid number of the rosin compound may he measured according to a method defined in ES K-5601-2-1.

Assuming that the total solid content of a low-moisture permeable layer forming composition is 100% by mass, the content of a rosin compound is preferably 1% by mass to 50% by mass, more preferably 5% by mass to 30% by mass, and still more preferably 10% by mass to 25% by mass from the viewpoint of remarkability of reduction in moisture permeability.

In the present invention, a boronic acid monomer is also preferably contained in the low-moisture permeable layer. When the boronic acid monomer is contained in the low-moisture permeable layer, the adhesion of the low-moisture permeable layer and the polarizer may be enhanced.

(Boronic Acid Monomer)

The boronic acid monomer is a compound having a boronic acid represented by Formula (VIII) and a polymerizable group, and plays a role to enhance the adhesion of the polarizer and the low-moisture permeable layer, as described above.

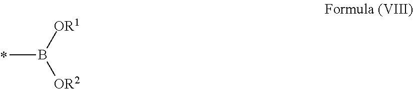

In Formula (VIII), R¹ and R² each independently represent a hydrogen atom, or a substituted or unsubstituted, aliphatic hydrocarbon group, aryl group, or a heterocyclic group.

Examles of the aliphatic hydrocarbon group may include a substituted or unsubstituted, straight or branched alkyl group having 1 to 20 carbon atoms (e.g., a methyl group, an ethyl group, and an iso-propyl group), a substituted or unsubstituted cyclic alkyl group having 3 to 20 carbon atoms (e.g., a cyclohexyl group), an alkenyl group having 2 to 20 carbon atoms (e.g., a vinyl group).

Examples of the aryl group may include a substituted or unsubstituted phenyl group having 6 to 20 carbon atoms (e.g., a phenyl group and tolyl group), a substituted or unsubstituted naphthyl group having 10 to 20 carbon atoms.

Examples of the heterocyclic group may include a substituted or unsubstituted five- or six-membered group containing at least one hetero atom (e.g., a nitrogen atom, an oxygen atom, or a sulfur atom), such as, for example, pyridyl group, an imidazolyl group, a furyl group, a piperidyl group, and a morpholino group.

R¹ and R² may be bonded to each other to form a ring, for example, isopropyl groups of R¹ and R² may be bonded to form a 4,4,5,5-tetramethyl-1,3,2-dioxaborolane ring.

In Formula (VIII), R¹ and R² are preferably a hydrogen atom, a straight or branched alkyl group having 1 to 3 carbon atoms, and a case where R¹ and R² are boned to form a ring, and most preferably a hydrogen atom.

In Formula (VIII), * represents a bonding site.

Meanwhile, the number of boronic acids represented by Formula (VIII) is not particularly limited, but may be 1 or a plurality of numbers (2 or more).

Meanwhile, at least one of the hydrocarbon groups contained in the aliphatic hydrocarbon group, the aryl group, and the heterocyclic group may be substituted with arbitrary substituents. Examples of the kinds of the substituents may include substituents described in paragraph 0046 of Japanes Patent Laid-Open Publication No. 2013-054201.

The kind of the polymerizable group is not particularly limited, and examples thereof may include a radical polymerizable group and a cationic polymerizable group. Examples of the radical polymerizable group may include a (metho)acryloyl group, an acrylamide group, a vinyl group, a styryl group, and an allyl group. Examples of the cationic polymerizable group may include a vinyl ester group, an oxyranyl group, and an oxetanyl group. Among those, a (meth)acryloyl group, a styryl group, a vinyl group, an oxyranyl group, or an oxetanyl group is preferred, a (meth)acryloyl group or a styryl group is more preferred, and a (meth)acryloyl group is particularly preferred.

Meanwhile, the (meth)acryloyl group is a concept including both an acryloyl group and a methacryloyl group.

The number of the polymerizable groups is not particularly limited, but may be 1 or a plurality of numbers (2 or more).

The molecular weight of the boronic acid monomer is not particularly limited, but is preferably 120 to 1200, and more preferably 180 to 800 from the viewpoint of excellent compatibility with a polyfunctional monomer.

A suitable aspect of the boronic acid monomer may be exemplified by a boronic acid represented by Formula (IX) from the viewpoint of more excellent adhesion of the polarizer and the resin layer.

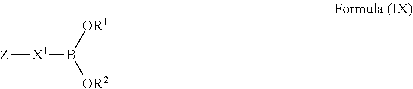

The definitions of R¹ and R² in Formula (IX) are the same as those described above.

Z represents a polymerizable group. The definition of the polymerizable group is the same as those described above.

X¹ represents a single bond or a divalent linking group. Examples of the divalent linking group may include a divalent linking group selected from —O—, —CO—, —NH—, —CO—NH—, —COO—, —O—COO—, an alkylene group, an arylene group, a heterocyclic group (a heteroaryl group), and combinations thereof.

Meanwhile, examples of the combinations may include -arylene group-COO-arylene group-O-alkylene group-, and -arylene group-COO-alkylene group-.

Hereinafter, specific examples of the boronic acid monomer are represented, but the present invention is not limited thereto.

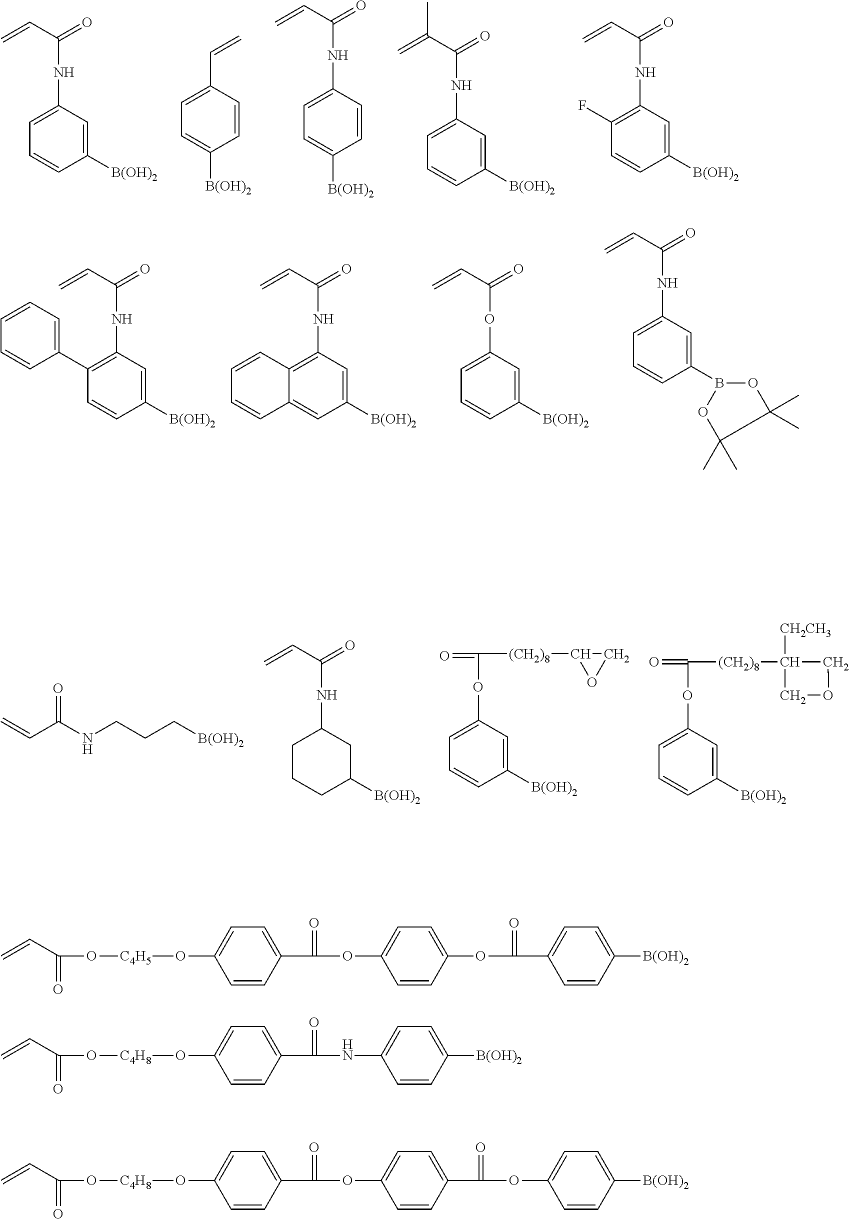

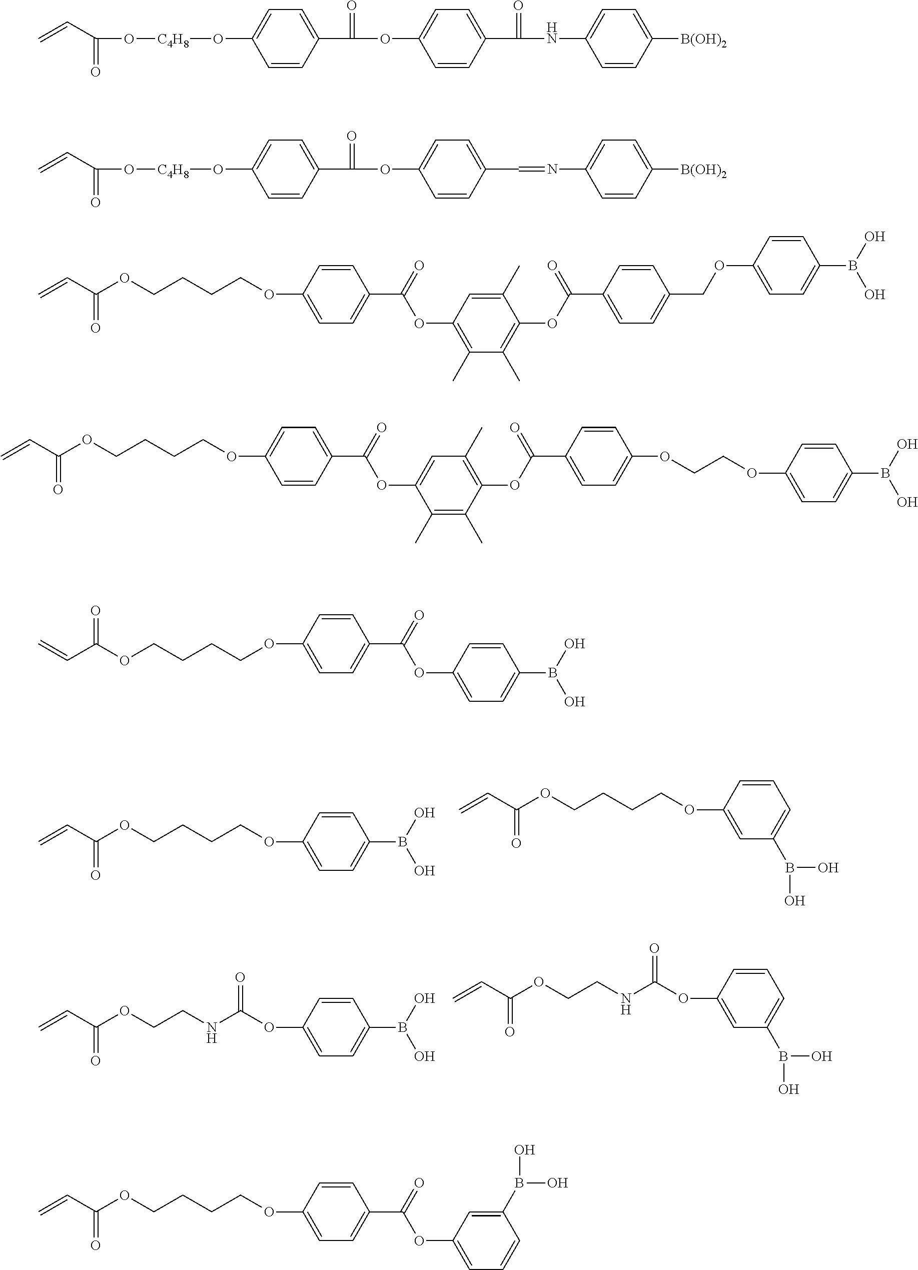

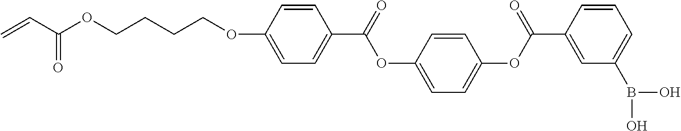 [SMILES: C=CC(=O)OCCCCOc1ccc(C(=O)Oc2ccc(OC(=O)c3cccc(B(O)O)c3)cc2)cc1]

In the present invention, the content of the boronic acid monomer is preferably 0.005% by mass to 3% by mass, and more preferably 0.01% by mass to 2% by mass based on the total solid content of the low-moisture permeable layer forming composition.

[Inorganic Layered Compound]

To further reduce the moisture permeability of the low-moisture permeable layer in the present invention, it is also preferable to disperse an inorganic layered compound in a binder which can be used in the above-described low-moisture permeable layer. Since the inorganic layered compound has a hydrophilic surface, it is preferably organically modified.

The inorganic layered compound refers to an inorganic compound having a structure in which unit crystal layers are laminated and exhibiting a property of swelling or cleaving by coordinating or absorbing a solvent between layers. Examples of such an inorganic compound may include swelling hydrous silicate, such as smectitc group clay minerals (montmorillonite, saponite and hectorite, and the like), palm curite group clay minerals, kaolinite group clay minerals and phyllosilicates (mica and the like). Furthermore, a synthetic inorganic layered compound is also preferably used. Examples of a synthetic inorganic layered compound include synthetic smectite (hectorite, saponite, stevensite, and the like), and synthetic mica. Smectite, montmorillomite and mica are preferred. An inorganic layered compound that may be used is commercially available under the trade names of MEB-3 (a synthetic mica aqueous dispersion manufactured by Co-op Chemical Co.), ME-100 (synthetic mica manufactured by Co-op Chemical Co., Ltd.), S1ME (synthetic mica manufactured by Co-op Chemical Co., Ltd.), SWN (synthetic smectite manufactured by Co-op Chemical Co., Ltd.), SWF (synthetic smectite manufactured by Co-op Chemical Co., Ltd.), Kunipia F (purified bentonite manufactured by Kunimine Industries Co., Ltd.), Ben-gel (purified bentonite manufactured by HOJUN Co., Ltd.), Ben-gel HV (purified bentonite manufactured by HOJUN Co., Ltd.), Ben-gel FW (purified bentonite manufactured by HOJUN Co., Ltd.), Ben-get Bright 11 (purified bentonite manufactured by HOJUN Co., Ltd.), Ben-gel Bright 23 (purified bentonite manufactured by HOJUN Co., Ltd.), Ben-gel Bright 25 (purified bentonite manufactured by HOJUN Co., Ltd.), Ben-gel A (purified bentonite manufactured by HOJUN Co., Ltd.), and Ben-gel 2M (purified bentonite manufactured by HOJUN Co., Ltd.).

Also, such an inorganic layered compound is preferably provided by organically modifying the above-described inorganic layered compound.

Examples of an organically modified inorganic layered compound include an organically modified inorganic layered compound described in paragraphs 0038 to 0044 of Japanese Patent Laid-Open Publication No. 2012-234094.

A swelling layered inorganic compound is preferably atomized from the viewpoint of both the low moisture permeability and the adhesion of the transparent support and the low-moisture permeable layer. The atomized swelling layered inorganic compound is generally plate-like or flat, and a planar shape is not particularly limited and may be amorphous or like. The average particle size of an atomized swelling layered inorganic compound (the average particle size of a planar shape) may be, for example, preferably 0.1 μm to 10 μm, more preferably 0.1 μm to 8 μm, and particularly preferably 0.1 μm to 6 μm.

<UV Absorber>

The polarizing plate of the present invention, which includes the low-moisture permeable layer, is used in a member of a liquid crystal display device. However, from the viewpoint of suppressing deterioration of the polarizing plate or liquid crystal cell, the low-moisture permeable layer is preferably a layer having a UV absorbing property. Specifically, the polarizing plate may be imparted a UV absorbing property by containing the UV absorber in the low-moisture permeable layer.

As the UV absorber, well-known UV absorbers may be used. Examples thereof may include those described in Japanese Patent Laid-Open Publication No. 2001-72782 or Japanese National Publication of International Patent Application No. 2002-543265. Specific and preferred examples of the UV absorber may include the same as in the specific and preferred examples as described below in the Section entitled {Transparent Support}, Subsection entitled [UV Absorber].

<Solvent>

The low-moisture permeable layer forming composition may contain a solvent. As the solvent, various types of solvent may be used in consideration of the solubility of monomers, the drying property of coating, the dispersibility of light-transmitting particles. Examples of the organic solvent may include dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methyl cyclohexanone, ethyl formate, propyl formate pentyl, methyl acetate, ethyl acetate, propyl acetate, methyl propionate, ethyl propionate, γ-butyrolactone, 2-methoxy-methyl acetate, 2-ethoxy-methyl acetate, 2-etboxyethyl acetate, 2-ethyl ethoxypropionate, 2-methoxy ethanol, 2-propoxy ethanol, 2-butoxy ethanol, 1,2-diacetoxy acetone, acetylacetone, diacetone alcohol, methyl acetoacetate, methyl alcohol such as ethyl acetoacetate, ethyl alcohol, isopropyl alcohol, n-butyl alcohol, cyclohexyl alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethyl cyclohexane, benzene, toluene, and xylene, which may be used either alone or in combination of two or more thereof.

Of the above-listed solvents, it is preferred to use at least one of methyl acetate, ethyl acetate, methyl ethyl ketone, acetylacetone, acetone, toluene, and xylene.

It is preferred to use a solvent in such an amount that the solid content of the low-moisture permeable layer forming composition ranges preferably 20% by mass to 80% by mass, more preferably 30% by mass to 75% by mass, and more preferably 40% by mass to 70% by mass.

(Configuration of Low-Moisture Permeable Layer and Method of Manufacturing the Same)

The low-moisture permeable layer of the present invention may be a single layer or may be provided in the form of a plurality of layers. Although lamination of the low-moisture permeable layer is not particularly limited, it is preferred to manufacture the low-moisture permeable layer by co-casting with the transparent support, or form the low-moisture permeable layer on the transparent support by coating, and it is more preferred to form the low-moisture permeable layer on the transparent support by coating.

(Film Thickness of Low-Moisture Permeable Layer)

The film thickness of the low-moisture permeable layer of the present invention is greater than 5 μm and equal to 30 μm or less. If the film thickness is greater than 5 μm, sufficient polarizer durability may be realized. If the film thickness is 30 μm or less, a thin polarizer, furthermore, a thin polarizing plate may be realized. The film thickness of the low-moisture permeable layer is preferably 7 μm to 20 μm, more preferably 7 to 18 μm, particularly preferably 7 μm to 17 μm, and most preferably 7 μm to 15 μm.

(Moisture Permeability of Low-Moisture Permeable Layer)

The low-moisture permeable layer in the present invention preferably has a moisture permeability of 100 g/m²/day under an environment of 40° C. and 90% RH.

From a gas-permeation formula of a composite film (e.g., Tsutomu Nakawa, “Science of Barrier Property of Packaging Material” (Packaging Fundamental Course 5), pp. 68-72, The Society of Packaging Science & Technology, Japan), the moisture permeability of the polarizing plate protective film in a normal state is denoted as J_{f}, the moisture permeability of the transparent support is denoted as Jₛ, and the moisture permeability of the low-moisture permeable layer when the polarizing plate is separated into the transparent support and the low-moisture permeable layer is denoted as J_{b}. As a result, the following equation is established:

1/Jₛ=1/Jₛ₊₁/J_{b} Equation (1)

The moisture permeability of the polarizing plate J_{f} and the moisture permeability of the transparent support Jₛ may be directly measured. Based on the measurements thereof, the moisture permeability of the low-moisture permeable layer J_{b} may be calculated.

(Moisture Permeability Per Unit Film Thickness of Low-Moisture Permeable Layer)

It is generally known that the moisture permeability is inversely proportional to the film thickness. Accordingly, the moisture permeability that can be reached by the low-moisture permeable layer within the above-described film thickness range is determined by the moisture permeability per unit film thickness, which is a characteristic value of material, and as the value is smaller, a lower moisture permeability may be achieved.

The moisture permeability of the low-moisture permeable layer per film thickness of 10 μm is preferably 100 g/m²/day or less. When the moisture permeability of the low-moisture permeable layer is 100 g/m²/day or less, deformation and deterioration of the polarizing plate and the like may be suppressed, and the polarizer durability may be enhanced. The moisture permeability of the low-moisture permeable layer is preferably 73 g/m²/day or less, more preferably 40 g/m²/day or less, and particularly preferably 30 g/m²/day or less. The moisture permeability is a value reached after the lapse of 24 hours at 40° C. and a relative humidity of 90% according to JIS Z-0208.

Meanwhile, the moisture permeability of the low-moisture permeable layer per film thickness of 10 μm is estimated from the moisture permeability of the transparent support and the polarizing plate and the film thickness of the low-moisture permeable layer, as follows.

The moisture permeability C_{b} (10 μm) relative to the 10-μm film thickness of the low-moisture permeable layer may be represented by the following equation based on the value of J_{b} calculated above:

C_{b}(10 μm)=J_{b}×d_{b}/10 [g/m²/day] Equation (2)

(wherein d_{b} [μm] is the film thickness of the low-moisture permeable layer, and as described above, may be calculated based on a difference in film thickness between before and after the lamination of the low-moisture permeable layer).

Subsequently, descriptions will be made on the transparent support included in the polarizing plate of the present invention.

{Transparent Support}

The polarizing plate of the present invention has a transparent support support on a surface of the polarizer that is opposite to the side having the low-moisture permeable layer.

[Material for Transparent Support]

The transparent support preferably contains a polymer as a main component (which accounts for 50% by mass or more in the transparent support). The polymer forming the transparent support is preferably excellent in optical performance transparency, mechanical strength, thermal stability, and isotropic property. Transparency as used in the present invention indicates that the transmittance of visible light is 60% or more, preferably 80% or more and particularly preferably 90% or more. Examples thereof may include a polycarbonate-based polymer, a polyester-based polymer such as polyethylene terephthalate or polyethylene naphthalate, and a styrene-based polymer such as polystyrene and an acrylonitrile-styrene copolymer (an AS resin). Further, the main component may be selected from polyolefin such as polyethylene and polypropylene, a polyolefin-based polymer such as an ethylene-propylene copolymer, a vinyl chloride-based polymer, an amide-based polymer such as nylon and aromatic polyamide, an imide-based polymer, a sulfone-based polymer, a polyethersulfone-based polymer, a polyether ether ketone-based polymer, a polyphenylene sulfide-based polymer, a vinylidene chloride-based polymer, a vinyl butyral-based polymer, an allylate-based polymer, a polyoxymethylene-based polymer, an epoxy-based polymer, a cellulose acylate-based polymer, a polyester-based polymer, a (meth)acylic polymer, and a cycloolefin-based polymer. A polymer obtained by mixing the polymers thereof may also be used.

In the following, as an example of the transparent support of the present invention, cellulose acylate-based polymer, a (meth)acrylic polymer, a polyester-based polymer, and a cycloolefin-based polymer will be mainly described in detail.

[Transparent Support Containing Cellulose Acylate-Based Polymer as Main Component]

The transparent support preferably contains a cellulose acylate-based polymer as a main component.

<Substitution Degree of Cellulose Acylate>

First, cellulose acylate prepared using cellulose as a raw material will be described below. The cellulose acylate is obtained by acylating hydroxyl groups of cellulose, and as a substituent thereof, any of acetyl groups, ranging from acyl groups having 2 carbon atoms to an acetyl group having 22 carbon atoms, may be used. In the cellulose acylate of the present invention, the substitution degree of an acyl group for the hydroxyl group of cellulose is not particularly limited, but the substitution degree may be calculated by measuring the bonding degree of an acetic acid and/or a carboxylic acid having 3 to 22 carbon atoms for acylating the hydroxyl group of cellulose. A measurement method may be performed in accordance with D-817-91 of ASTM.

The substitution degree of the acyl group for the hydroxyl group of cellulose is not particularly limited, but is preferably 2.50 to 3.00, more preferably 2.75 to 3.00, and still more preferably 2.85 to 3.00.

The acetic acid and/or the carboxylic acid having 3 to 22 carbon atoms for acylating the hydroxyl group of cellulose may be an aliphatic carboxylic acid or an aromatic carboxylic acid, and may be either alone or a mixture of two or more kinds. Examples of the cellulose esters acylated thereby may include an alkylcarbonyl ester, an alkenylcarbonyl ester, aromatic carbonyl ester, or an aromatic alkyl carbonyl ester of cellulose, each of which may further have a substituted group. Preferred examples of the acyl group may include an acetyl group, a propionyl group, a n-butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a cyclohexanecarbonyl group, an oleoyl group, a benzoyl group, a naphthylcarbonyl group, a cinnamoyl group, etc. Among others, an acetyl group, a propionyl group, a butanoyl group, a dodecanoyl group, an octadecanoyl group, a t-butanoyl group, an oleoyl group, a benzoyl group, a naphthylcarbonyl group, a cinnamoyl group, etc. are preferred, and an acetyl group, a propionyl group and a n-butanoyl group are more preferred.

<Polymerization Degree of Cellulose Acylate>

The polymerization degree of the cellulose acylate that is preferably used in the present invention ranges from 180 to 700 in terms of viscosity average polymerization degree, and in cellulose acetate, ranges more preferably from 180 to 550, still more preferably from 180 to 400 and particularly preferably from 180 to 350.

[Transparent Support Containing (Meth)Acrylic Polymer as Main Component]

The transparent support in the present invention also preferably contains a (meth)acrylic polymer as a main component, and more preferably contains a (meth)acrylic polymer having, in its main chain, at least any one of a lactone ring structure, an anhydrous glutaric acid ring structure, and a glutarimide ring structure, as a main component.

Meanwhile, the general idea of the (meth)acrylic polymer includes both of a methacrylic polymer and an acrylic polymer, Further, the (meth)acrylic polymer also includes an acrylate/methacrylate derivative, and particularly an acrylate ester/methacrylate ester (co)polymer.

((Meth)Acrylic Polymer)

The (meth)acrylic polymer preferably contains, as a repeating structural unit, a repeating structural unit derived from a (meth)acrylate ester monomer.

The (meth)acrylic polymer may contain, as a repeating structural unit, a repeating structural unit constructed by polymerizing at least one selected from a hydroxyl group-containing monomer, an unsaturated carboxylic acid, and a monomer represented by the following Formula (201).

CH₂═C(X)R²⁰¹ Formula (201):

(where R²⁰¹ represents a hydrogen atom or a methyl group, X represents a hydrogen atom, an alkyl group having 1 to 20 carbon atoms, an aryl group, a —CN group, a —CO—R²⁰² group or a —O—CO—R²⁰³ group, and R²⁰² and R²⁰³ represent a hydrogen atom or an organic residue having 1 to 20 carbon atoms).

The (meth)acrylate ester is not particularly limited, but examples thereof may include an acrylic acid ester such as methyl acrylate, ethyl acrylate, n-butyl acrylate, isobutyl acrylate, tert-butyl acrylate, cyclohexyl acrylate and benzyl acrylate; and a methacrylic acid ester such as methyl methacrylate, ethyl methacrylate, propyl methacrylate, n-butyl methacrylate, isobutyl methacrylate, tert-butyl methacrylate, cyclohexyl methacrylate and benzyl methacrylate, which may be used either alone or in combination of two or more thereof. Among those, methyl methacrylate is preferred because it is excellent in heat resistance and transparency.

In case of using the (meth)acrylate ester, its content ratio in monomer components provided in a polymerization process is preferably 10% by mass to 100% by mass, more preferably 10% by mass to 100% by mass, still more preferably 40% by mass to 100% by mass, and particularly preferably 50% by mass to 100% by mass in order to fully exhibit the effects of the present invention.

The hydroxyl group-containing monomer includes a 2-(hydroxyalkyl)acrylate ester such as α-hydroxymethylstyrene, α-hydroxyethylstyrene, and methyl 2-(hydroxyethyl)acrylate; and a 2-(hydroxyalkyl)acrylic acid such as 2-(hydroxyethyl)acrylic acid, which may be used either alone or in combination of two or more thereof.

In case of using the hydroxyl group-containing monomer, its content ratio in monomer components provided in a polymerization process is preferably 0% by mass to 30% by mass, more preferably 0% by mass to 20% by mass, still more preferably 0% by mass to 15% by mass, and particularly preferably 0% by mass to 10% by mass in order to fully exhibit the effects of the present invention.

Examples of the unsaturated carboxylic acid may include an acrylic acid, a methacrylic acid, a crotonic, acid, an α-substituted acrylic acid, and an α-substituted methacrylic acid, which may be used either alone or in combination of two or more thereof. Among those, an acrylic acid and a methacrylic acid are preferred from the viewpoint of fully exhibiting the effects of the present invention.

In case of using the unsaturated carboxylic acid, its content ratio in monomer components provided in a polymerization step is preferably 0% by mass to 30% by mass, more preferably 0% by mass to 20% by mass, still more preferably 0% by mass to 15% by mass, and particularly preferably 0% by mass to 10% by mass in order to fully exhibit the effects of the present invention.

Examples of the monomer represented by Formula (201) may include styrene, vinyloluene, α-methylstyrene, acrylonitrile, methyl vinyl ketone, ethylene, propylene and vinyl acetate, which may be used either alone or in combination of two or more thereof. Among those, styrene and α-methylstyrene are preferred from the viewpoint of fully exhibiting the effects of the present invention.

In case of using the monomer represented by Formula (201), its content ratio in monomer components provided in a polymerization step is preferably 0% by mass to 30% by mass, more preferably 0% by mass to 20% by mass, still more preferably 0% by mass to 15% by mass, and particularly preferably 0% by mass to 10% by mass, from the viewpoint of fully exhibiting the effects of the present invention.

[(Meth)Acrylic Polymer Having Ring Structure in Main Chain]

Among (meth)acrylic polymers, a polymer having a ring structure in its main chain is preferred. By introducing a ring structure into the main chain, the rigidity of the main chain may be increased to thereby improve heat resistance.

Among (meth)acrylic polymers having a ring structure in their main chain, any of a polymer having a lactone ring structure in the main chain, a polymer having an anhydrous glutaric acid ring structure in the main chain, and a polymer having a glutarimide ring structure in the main chain is preferred in the present invention, Above all, a polymer having a lactone ring structure in the main chain is more preferred.

These polymers having a ring structure in the main chain will be described in sequence.

((Meth)Acrylic Polymer Having Lactone Ring Structure in Main Chain)

The (meth)acrylic polymer having a lactone ring structure in its main chain (hereinafter, also referred to as a lactone ring-containing polymer) is a (meth)acrylic polymer having a lactone ring in the main chain, and resins described in Japanese Patent Laid-Open Publication No. 2006-096960 and Japanese Patent Laid-Open Publication No. 2007-063541.

(Polymer Having Glutaric Anhydride Ring Structure in Main Chain)

The polymer having a glutaric anhydride ring structure in its main chain refers to a polymer having a glutaric anhydride unit, and resins described in Japanese Patent Laid-Open Publication No. 2009-210905 and Japanese Patent Laid-Open Publication No. 2009-030001.

((Meth)Acrylic Polymer Having Glutarimide Ring Structure in Main Chain)

The (meth)acrylic polymer having a glutarimide ring structure in its main chain (hereinafter, also referred to as a glutarimide-based resin) is able to express a preferred characteristic balance in optical property or heat resistance as a result of having a glutarimide ring structure in its main chain.

The glutarimide-based resin is described in U.S. Pat. Nos. 3,284,425 and 4,246,374, and Japanese Patent Laid-Open Publication No. H2-153904, and may be obtained by using a resin mainly formed of a raw material such as a methacrylic acid methylester as a resin having an imidizable unit and imidizing the resin having an imidizable unit by using ammonia or substituted amine.

[Transparent Support Containing Polyester-Based Polymer as Main Component]

Examples of the polyester-based polymer may include polyethylene terephthalate, polyethylene isophthalate, polyethylene-2,6-naphthalate, polybuthylene terephthalate, and 1,4-cyclohexane dimethylene terephthalate, and two or more kinds thereof may be used as necessary. Among those, polyethylene terephthalate and polyethylene-2,6-naphthalate are preferably used. From the viewpoint of cost for material, polyethylene terephthalate is more preferably used. That is, in the liquid crystal display device of the present invention, the first protective film is preferably a polyethylene terephthalate film. Meanwhile, from the viewpoints that the moisture permeability with the sema film thickness during the thinning may be reduced, and that the display unevenness after moisture-heat aging may be further improved, polyethylene-2,6-naphthalate is more preferably used.

The polyethylene terephthalate is polyester having a structural unit derived from terephthalic acid as a dicarboxylic acid component and a structural unit derived fro ethylene glycol as a diol component, and may have 80 mol % of ethylene terephthalate based on the total repeat units, or may contain structural units derived from other copolymerizable components. Examples of other copolymerizable component may include a dicarbonxylate component such as isophthalic acid, p-β-oxyethoxybenzoic acid, 4,4′-dicarboxydiphenyl, 4,4′-dicarboxybenzophenone, bis(4-carboxyphenyl)ethane, adipic acid, sebacic acid, sodium 5-sulfoisophthalate, and 1,4-dicarboxycyclohexane, and a diol component such as propylene glycol, butanediol, neopentyl glycol, diethylene glycol, cyclohexanediol, an ethylene oxide adduct of bisphenol A, polyethylene glycol, polypropylene glycol, and polytetramethylene glycol. The dicarboxylic acid components or the diol components may be used in combination of two or more thereof as necessary. Further, oxycarboxylic acid such as p-oxybenzoic acid may be used in combination with the carboxylic acid component or the diol component. As other copolymerizable components, a dicarboxylic acid component and/or a diol component containing a small amount of an amide bond, a urethane bond, an ether bond, or a carbonate bond may be used. As a method for preparing polyethylene terephthalate, any method, such as a so-called direct polymerization method of directly reacting terephthalic acid and ethylene glycol, and optionally other dicarboxylic acid and/or other diols, or a so-calle transesterification reaction of transesterifying dimethyl ester of terephthalic acid and ethylene glycol, and optionally other dimethyl ester of other dicarboxylic acids and/or other diols, may be applied.

The method of manufacturing the transparent support containing a polyester-based polymer as a main component is not particularly limited, but the transparent support is preferably manufactured by the following method ino order to impart the above-described characteristics.

It is preferred to first melt-extrude a polyester-based polymer in a film shape, which is then cooled and solidified as an unstretched film, optionally coat a coating liquid to form an easy adhesive layer, and stretch the unstretched film 3 to 10 times, and preferably 3 to 7 times in a width direction at a temperature of Tg of the polyester film to (Tg+60)° C. The first protective film is preferably polyester film that is at least uniaxially stretched, and more preferably a polyester film that is at least uniaxially stretched in the width direction, from the viewpoint of largely exhibiting in-plane retardation Re.

Further, the transparent support containing a polyester-based polymer as a main component is preferably a polyester film that is at least biaxially stretched.

[Transparent Support Containing Cycloolefin-Based Polymer as Main Component]

The cycloolefin-based polymer refers to a polymer resin having a cyclic olefin structure.

Examples of the polymer resn having a cyclic olefin structure used in the present invention include (1) a norbornene-basd polymer, (2) monocyclic polymer of cyclic olefin, (3) polymer of cyclic conjugated diene, (4) vinyl alicyclic hydrocarbon polymer, and hydride of (1) to (4).

Preferred polymers in the present invention include a cycloolefin-based polymer that is an addition (co)polymer containing at least one repeating unit represented by the following Formula (II), and optially a cycloolefin-based polymer that is an addition (co)polymer further containing at least one repeating unit represented by Formula (I). Further, a ring-opened (co)polymer containing at least one cyclic repeating unit represented by Formula (III) may also be suitably used.

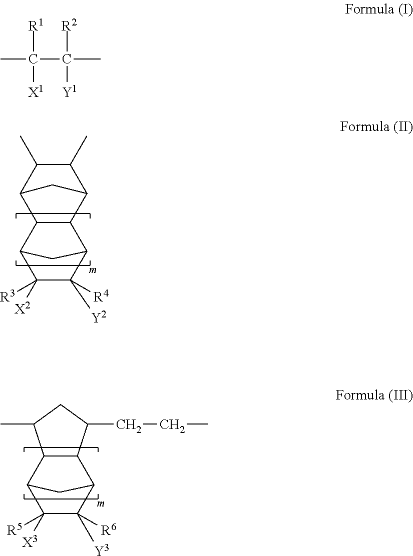

In Formulas (I) to (III), represents an integer of 0 to 4. R¹ to R⁶ represent a hydrogen atom or a hydrocarbon group having 1 to 10 carbon atoms, and X¹ to X³, and Y¹ to Y³ represent a hydrogen atom, a hydrocarbon group having 1 to 10 carbon atoms, a halogen atom, a hydrocarbon group having 1 to 10 carbon atoms which is substituted with a halogen atom, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, or (—CO)₂O or (—CO)₂NR¹⁵ formed by X¹ and Y¹ or X² and Y² or X³ and Y³. Meanwhile, R¹¹, R¹², R¹³, R¹⁴, R¹⁵ represent a hydrogen atom or a hydrocarbon group having 1 to 20 carbon atoms, Z represents a hydrocarbon group or a hydrocarbon group substituted with halogen, W represents SiR¹⁶ₚD₃₋ₚ (R¹⁶ represents a hydrocarbon group having 1 to 10 carbon atoms, D represents a halogen atom, —OCOR¹⁶ or —OR¹⁶, and p represents an integer of 0 to 3), and n represents an integer of 0 to 10.

As disclosed in Japanese Patent Laid-Open Publication No. H1-240517, Japanese Patent Laid-Open Publication No. H7-196736, Japanese Patent Laid-Open Publication No. S60-26024, Japanese Patent Laid-Open Publication No S62-19801, Japanese Patent Laid-Open Publication No. 2003-1159767, or Japanese Patent Laid-Open Publication No. 2004-309979, a norbornene polymer hydride may be produced through addition polymerization or metathesis ring-cleavage polymerization of polycyclic unsaturated compounds followed by hydrogenation. In the norbornene polymer used in the present invnention, R⁵ and R⁶ are preferably a hydrogen atom or —CH₃, X³ and Y³ are preerably a hydrogen atom, Cl, or —COOCH₃, and the other groups may be suitably selected. The norbornene-based resin is sold by JSR as trade names of ARTON G or ARTON F, and by Nippon Zeon as trade names of ZEONOR ZF14, ZF16, ZEONEX 250, or ZEONEX 280, and these may be used herein.

Norbornene-based addition (co)polymers are disclosed in Japanese Patent Laid-Open Publication No. H10-7732, Japanese National Publication of International Patent Application No. 2002-504184, U.S. Patent Laid-Open Publication No. 2004229157A1 and WO2004/070463A1. They may be obtained through addition polymerization of norbornene-based polycyclic unsaturated compounds. Further, if desired, norbornene-based polycyclic unsaturated compounds may be addition-polymerized with conjugated dienes such as ethylene, propylene, butene, butadiene, or isoprene; non-conjugated dienes such as ethylidene norbornene; linear diene compounds such as acrylonitrile, acrylic acid, methacrylic acid, maleic anhydride, acrylate ester, methacrylate ester, maleimide, vinyl acetate, or vinyl chloride. Such norbornene-based addition (co)polymers are sold by Mitsui Chemical as a trade name of Apel series, including various grades having a different glass transition temperature (Tg), for example, APL8008T (Tg 70° C.), APL6013T (Tg 125° C.), and APL6015T (Tg 145° C.). Pellets are sold by Polyplastic as TOPAS8007, 6013, 6015. Further, Appear3000 is sold by Ferrania.

In the present invention, the glass transition temperature (Tg) of the cycloolefin-based polymer is not limited, and a cycloolefin-based having high Tg of, for example, 200° C. to 400° C. may also be used.

[UV Absorber]

A UV absorber preferably used in the transparent support will be described. The polarizing plate of the present invention, including the transparent support, is used in a member for a liquid crystal display, but, from the viewpoint of suppressing deterioration of liquid crystal cells, it is preferred to cotanin a UV absorber. A UV absorber having an excellent ability of absorbing an ultraviolet ray at a wavelength of 370 nm or less and, from the viewpoint of sound liquid crystal display property, having a little absorption of visible light at a wavelength of 400 nm or more is preferably used. The UV absorber may be used either alone or in combination of two or more thereof. Examples of the UV absorber may include those described in Japanese Patent Laid-Open Publication No. 2001-72782 and Japanese National Publication of International Patent Application No. 2002-543265. Specific examples of the UV absorber include an oxybenzophenone-based compound, a benzotriazole-based compound, a salicylic acid ester-based compound, a benzophenone-based compound, a cyanoacrylate-based compound, and a nickel complex salt-based compound.

[Other Additives]

In the transparent support, additives such as a matting agent, a retardation developer, a plasticizer, a UV absorber, a deterioration inhibitor, a release agent, an infrared absorber and a wavelength dispersion adjuster may be added. These may be solid or oily substances. That is, the additives are not particularly limited in their melting point or boiling point. For example, UV absorbing materials having a temperature of 20° C. or less and 20° C. or more can be mixed, and plasticizers can be mixed in the same manner. Such mixtures are described, for example, in Japanese Patent Laid-Open Publication No. 2001-151901. Further, infrared absorbing dyes are described, for example, in Japanese Patent Laid-Open Publication No. 2001-194522. As for the timing of addition, an additive may be added at any time during the process of dope preparation. However, a further step of adding an additive may be added to the final preparation step of the dope preparation process. The amount of each material added is not particularly limited so long as its function is exerted. Also, in a case where a polarizing plate protective film is formed in multilayers, the type and amount of additive added in the respective layers may differ from each other, as described, for example, in Japanese Patent Laid-Open Publication No. 2001-151902. These techniques have been known in the prior art. Details thereof are described in JIII Journal of Technical Disclosure (Journal of Technical Disclosure No. 2001-1745, Mar. 15, 2001, Japan Institute of Invention and Innovation), pp. 16-22, and the materials described in detail therein are preferably used.

Further, the transparent support may also contain rubbery partielse, and examples thereof may include an acrylic particle such as a soft acrylic resin, an acryl rubber, and a gum-acrylic graft-type core-shell polymer, or a styrene-elastomer copolymer. Further, additives capable of improving impact resistance and stress whitening resistance, as described, for example, in Examined Japanese Patent Application Publication No. S60-17406 and Examined Japanese Patent Application Publication No. H3-39095, are also preferably used.

In the transparent support, when these additives are added, the total additive content is preferably 50% by mass or less, and more preferably 30% by mass or less based on the transparent support.

Thanks to such additives, the film is improved in brittleness, which in turn greatly improves the folding resistance test (for example, evaluation of cracks when bent by 180 degrees).

<Properties of Transparent Support>

(Thickness of Transparent Support)

The film thickness of the transparent support is preferably 35 μm, more preferably 30 to 10 μm, and particularly preferably 25 to 15 μm. By controlling the film thickness to fall within the range above, it is possible to reduce panel unevenness involved in a change to the environment where a liquid crystal display device is placed after laminating the low-moisture permeable layer, that is, a change in temperature and humidity.

(Moisture Permeability of Transparent Support)

The moisture permeability of the transparent support is measured under the condition of 40° C. and a relative humidity of 90% based on JIS Z-0208.

The moisture permeability of the transparent support is preferably 1,600 g/m²/day or less, more preferably 950 g/m²/day or less, and particularly preferably 700 g/m²/day or less. By controlling the moisture permeability of the transparent support to fall within the range above, it is possible to prevent a liquid crystal cell of a liquid crystal display device, which is provided with the polarizing plate protective film having the low-moisture permeability layer laminateded thereon, from warping or causing light leakage over time in a normal temperature environment and a high-humidity environment and a high-temperature high-humidity environment.

(Moisture Permeability Per Unit Film Thickness of Transparent Support)

As described above in the section entitled (Moisture Permeability Per Unit Film Thickness) in relation to the low-moisture permeable layer, the moisture permeability of the transparent support having a thickness of 10 μm is provided by the following equation.

Cₛ(10 μm)=Jₛ×dₛ/1.0 [g/m²/day]

(wherein dₛ [μm] is a film thickness of the transparent support, and Jₛ is the moisture permeability of the transparent support).

The moisture permeability relative to the 10-μm film thickness of the transparent support is preferably 50 g/m²/day to 2,500 g/m²/day, more preferably 80 g/m²/day to 2,000 g/m²/day still more preferably 100 g/m²/day to 1,500 g/m²/day, and particularly preferably 150 g/m²/day to 1,200 g/m²/day. (The moisture permeability is a value measured according to JIS Z-0208 after the lapse of 24 hours under a temperature of 40° C. and a relative humidity of 90%).

At the lower limiting value or more, a sufficient effect of reduced moisture permeation may be achieved, and at the upper limiting value or less, display unevenness may be effectively suppressed.

(Surface Treatment of Transparent Support)

In some cases, the transparent support is subjected to a surface treatment to thereby enhance the adhesion of the transparent support to the low-moisture permeable layer. For example, a glow discharge treatment, an ultraviolet irradiation treatment, a corona treatment, a flame treatment, or an acid or alkali treatment may be used. The glow discharge treatment as used herein may be a treatment with low-temperature plasma occurring in a low-pressure gas of 10⁻³ Torr to 20 Torr, and a plasma treatment under atmospheric pressure is also preferred. A plasma-exciting gas refers to a gas excited by plasma under the above-described conditions and includes, for example, argon, helium, neon, krypton, xenon, nitrogen, carbon dioxide, fluorocarbons such as tetrafluoromethane, and a mixture thereof. Details thereof are described in JIII Journal of Technical Disclosure (Journal of Technical Disclosure No. 2001-1745, Mar. 15, 2001, Japan Institute of Invention and Innovation), pp. 30 to 32, and those described therein may be preferably used in the present invention.

{Polarizer}

In the present invention, any general polarizer may be used, and examples threof may include an iodine-based polarization film, a dye-based polarization film using a dichroic dye, or a polyene-based polarization film. The iodine-based polarization film and the dye-based polarization film may be prepared generally using a polyvinyl alcohol-based film. The iodine-based polarization film may be obtained by immersing a polyvinyl alcohol-based film in an iodine solution and strecting the film. Details of the polarizer are described, for example, in paragraph 0117 of Japanese Patent Laid-Open Publication No. 2011-136503.

Meanwhile, the thickness of the polarizer in the present invention is 15 μm or less, and particularly preferably 8 μm to 5 μm. If the thickness of the polarizer is 15 μm or less, a thin polarizing plate may be realized.

[Adhesion Layer (Adhesive Layer), Adhesive]

In the polarizing plate of the present invention, the polarizer and the low-moisture permeable layer are laminated directly or via an adhesive layer.

In the present specification, the “adhesion” is used as a concept including “glue”.

An adhesve used in the adhesive layer refers to, for example, a material with a ratio of a storage modulus G′ and a loss modulus G″ (tan δ=G″/G′) of 0.001 to 1.5 as measured by a dynamic viscoelasticity measuring device, and includes an adhesive, a material susceptible to creep, and the like. The adhesive which may be used in the present invention includes, for example, an acrylate-based adhesive or a polyvinyl alcohol-based adhesive, but not limited threrto.

Further, examples of the adhesive may include an aqueous solution of a boron compound, a curable adhesive containituz no aromatic ring in the molecule, as described in Japanese Patent Laid-Open Publication No. 2004-245925, an active energy ray-curable adhesive essentially containing a photopolymerization initiator and an ultraviolet curable compound, in which the molar extinction coefficient is 400 or more at a wavelength of 360 nm to 450 nm as described in Japanes Patent Laid-Open Publication No. 2008-174667, and an active energy ray-curable adhesive containing (a) a (meth)acrylic compound having two or more (meth)acryloyl groups in the molecule, (b) a (meth)acrylic compound having a hydroxyl group in the molecule and having only one polymerizable double bond, and (c) a phenol ethylene oxide-modified acrylate or nonylphenol ethylene oxide-modified acrylate in the total amount of 100 parts by mass of the (meth)acrylic compund described in Japanes Patent Laid-Open Publication No. 2008-174667.

Examples of the adhesive used in the above-described adhesive layer may include a polyester-based resin, an epoxy-based resin, a polyurethane-based resin, a silicon-based resin, and an acrylic resin. These may be used either alone or in combination of two or more thereof. Particularly, the acrylic resin is preferred for the reason that reliabilyt such as water resistance, heat resistance, or light resistance, is excellent, adhesion and transparency are sufficient, and the refractive index is easily adjusted to be suitable for the liquid crystal display. Examples of the acrylic adhesive may include acrylic acid and ester thereof, methacrylic acid and ester thereof, a homopolymer of acrylic monomers such as acrylamide and acrylonitrile, or a copolymer thereof, and a copolymer of at least one of the above-mentioned acrylic monomers and an aromatic vinyl monomer such as vinyl acetate, maleic anhydride, and styrene. Particularly, preferred is a copolymer composed of a main monomer such as ethylene acrylate, butyrene acrylate, or 2-ethylhexyl acrylate, which exhibits an adhesive property, a monomer such as vinyl aceate, acrylonitrile, acrylamide, styrene, methacrylate, or methyl acrylate, which is a cohesive component, and a functional group-containing monoer such as methacrylic acid, acrylic acid, itaconic acid, hydroxyethyl methacrylate, hydroxypropyl methacrylate, dimethylaminoethyl methacrylate, dimethylaminoethyl methacrylate, acrylamide, methylol acrylamide, glycidyl methacrylate, or maleic anhydride, which enhances adhesive force or impart a crosslinking starting point, in which a glass transition point (Tg) is in a range of −60° C. to −15° C., and the weight average molecular weight is in a range of 200,000 to 1,000,000.

in the present invention, a sheet-like photocurable pressure-sensitive adhesive (described in Toagosei Group Research Annual Report 11 TREND 2011 No. 14) may also be used for the adhesive layer. This is an adhesion method suitable for the present invention because the adhesisve is convenient for bonding between optical films, is crosslinked and cured by ultraviolet rays (UV), and is enhanced in the storage modulus, the adhesive strength and the heat resistance.

[Film Thickness of Polarizing Plate]

The film thickness of the present invention is preferably 80 μm or less, and more preferably 73 μm to 57 μm.

{Hard Coat Layer}

In the present invention, in order to arrange the polarizing plate on the surface of the liquid crystal display device, a hard coat layer is preferably provided on a surface opposite to the polarizer of the low-moisture permeable layer.

In the present invention, the hard coat layer refers to a layer capable of increasing the pencil hardness (imparting a hard coat property) of the film by forming the layer on the film. The hard coat layer is not particularly limited so long as it is a layer imparting the hard coat property, and may be a layer having a function other than the hard coat property. Examples thereof may include an antiglare hard coat layer (also referred to as an antiglare layer) and an antistatic hard coat layer (also referred to as an antistatic layer). For practical purposes, the pencil hardness (JIS K-5400-5-1) after laminating the hard coat layer is preferably H or more, more preferably 2H or more, and most preferably 3H or more.

The thickness of the hard coat layer is preferably 0.4 μm to 35 μm, more preferably 1 μm to 30 μm, and most preferably 1.5 μm to 20 μm.

In the present invention, the hard coat layer may be formed as a single layer or multilayers. In case where the hard coat layer is formed as multilayers, the total thickness of all hard coat layers preferably falls within a higher thickness range.

[Layer Configuration of Polarizing Plate]

A preferred layer configuration in a case where the polarizing plate of the present invention is provided with a hard coat layer is as follows.

Transparent Support/Polarizer/Low-Moisture Permeable Layer/Hard Coat Layer

Transparent Support/Polarizer/Adhesive Layer/Low-Moisture Permeable Layer/Hard Coat Layer

Transparent Support/Polarizer/Low-Moisture Permeable Layer/Hard Coat Layer/Antireflective Layer

Transparent Support/Polarizer/Adhesive Layer/Low-Moisture Permeable Layer/Hard Coat Layer/Antireflective Layer

Transparent Support/Polarizer/Low-Moisture Permeable Layer/Hard Coat Layer/Antirefiective Layer/Antifouling Layer

Transparent Support/Polarizer/Low-Moisture Permeable Layer/Hard Coat Layer/Antireflectiven Layer/Antifouling Layer

[Hard Coat Layer Forming Composition]

In the present invention, the hard coat layer may be formed by coating a support with a composition containing an ethylenically unsaturated double bond-containing compound, a polymerization initiator, and if necessary, a light-transmitting particle, a fluorine-containing or silicone-based compound, and a solvent directly or through another layer, and then drying and curing the coating. Respective components are described below.

[Compound Having Ethylenically Unsaturated Double Bond]

In the present invention, the hard coat layer forming composition may contain a compound having an ethylenically unsaturated double bond. The compound having an ethylenically unsaturated double bond is preferably a polyfunctional monomer having two or more polymerizable unsaturated groups, and more preferably a polyfunctional monomer having three or more kinds of polymerizable unsaturated groups. The polyfunctional monomer having two or more polymerizable unsaturated groups may function as a curing agent and enhance the strength or the scratch resistance of the coated film. More preferably, three or more polymerizable unsaturated groups are used. As for these monomers, a monofunctional or bifunctional monomer may also he used in combination with a tri- or higher-functional monomer.

Examples of the compound having an ethylenically unsaturated double bond may include a compound having a polymerizable functional group such as a (meth)acryloyl group, a vinyl group, a styryl group and an allyl group. Among those, a (meth)acryloyl group and —C(O)OCH═CH₂ are preferred. Particularly preferably, the following compounds containing three or more (meth)acryloyl groups in one molecule may be used.

Specific examples of the compound having a polymerizable unsaturated bond include (meth)acrylic acid diesters of an alkylene glycol, (meth)acrylic acid diesters of a polyoxyalkylene glycol, (meth)acrylic acid diesters of a polyhydric alcohol, (meth)acrylic acid diesters of an ethylene oxide or propylene oxide adduct, epoxy (meth)acrylates, urethane (meth)acrylates, and polyester (meth)acrylates.

Among those, esters of a polyhydric alcohol and a (meth)acrylic acid are preferred. Examples thereof may include 1,4-butanediol di(meth)acrylate, 1,6-hexanediol di(meth)acrylate, neopentyl glycol(meth)acryiate, ethylene glycol di(meth)acryate, triethylene glycol di(meth)acrylate, pentaerythritol tetra(meth)acrylate, pentaerythritol tri(meth)acrylate, trimethylolpropane tri(meth)acrylate. EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, 1,2,3-cyclohexane tetramethacrylate polyurethane polyacrylate, polyester polyacrylate, and caprolactone-modified tris(acryloxyethyl)isocyanurate.

As polyfunctional acrylate-based compounds having a (meth)acryloyl group, commercially available ones may be used, such as NK Ester A-TMMT manufactured by Shin-Nakamura Chemical Co., Ltd., and KAYARAD DPHA manufactured by Nippon Kayaku Co., Ltd. Polyfunctional monomers are described in paragraphs [0114] to [0122] of Japanese Patent Laid-Open Publication No. 2009-98658, and similarly described in the present invention.

The compound having an ethylenically unsaturated double bond is preferably a compound having a hydrogen-bondable substituent from the viewpoints of the adherence to a support, the low curling, and the immobilization of the fluorine-containing or silicone-based compound to be described below. The hydrogen-bondable substituent refers to a substituent in which an atom having high electronegativity, such as nitrogen, oxygen, sulfur and halogen, is covalently bonded to a hydrogen bond, and specific examples thereof may include OH—, SH—, —NH—, CHO—, and CHN—. Urethane (Meth)acrylates or (meth)acrylates having a hydroxyl group is preferred. Commercially available polyfunctional acrylates having a (meth)acryloyl group may also be used, and examples thereof may include NK Oligo U4HA and NK Ester A-TMM-3, both of which were manufactured by Shin-Nakamura Chemical Co., Ltd., and KAYARA DPET-30 manufactured by Nippon Kayaku Co., Ltd.

In order to fully increase the polymerization rate to thereby impart hardness, the content of a compound having an ethylenically unsaturated double bond in the hard coat layer-forming composition of the present invention is preferably 50% by mass or more, more preferably 60% by mass to 99% by mass, still more preferably 70% by mass to 99% by mass, and particularly preferably 80% by mass to 99% by mass, based on the total solid content in the hard coat layer forming composition, except the inorganic components.

In the present invention, a compound having a cycloaliphatic hydrocarbon and an ethylenically unsaturated double bond in a molecule is also preferably used in the hard coat layer forming composition. By using such a compound, low moisture permeability may be imparted to the hard coat layer. In order to enhance the hard coat property, it is more preferred to use a compound having a cycloaliphatic hydrocarbon and two or more ethylenically unsaturated double bonds in a molecule.

In a case where the hard coat layer forming composition contains a compound having a cycloaliphatic hydrocarbon and an ethylenically unsaturated double bond in a molecule, the compound having a cycloaliphatic hydrocarbon and an ethylenically unsaturated double bond in a molecule is contained in amount of preferably 1% by mass to 90% by mass, more preferably 2% by mass to 80% by mass, and particularly preferably 5% by mass to 70% by mass, based on the ethylenically unsaturated double bond-containing compound in the hard coat layer forming composition.

In a case where the hard coat layer forming composition contains a compound having a cycloaliphatic hydrocarbon and an ethylenically unsaturated double bond in a molecule, it is preferred to further contain a penta- or higher-functional (meth)acrylate.

In a case where the hard coat layer forming composition further contains a penta- or higher-functional (meth)acrylate, the penta- or higher-functional (meth)acrylate is contained in an amount of preferably 1% by mass to 70% by mass, more preferably 2% by mass to 60% by mass, and particularly preferably 5% by mass to 50% by mass, based on the ethylenically unsaturated double bond-containing compound in the hard coat layer forming composition.

[Light-Transmitting Particle]

In the present invention, a light-transmitting particle may be introduced into a hard coat layer to thereby impart a concavo-convex shape to the surface of the hard coat layer surface or impart an internal haze.

A light-transmitting particle that may be used in a hard coat layer includes, for example, a polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), crosslinked polystyrene particle (refractive index: 1.61), a polyvinyl chloride particle (refractive index: 1.60), a benzoguanamine-melamine formaldehyde particle (refractive index: 1.68), a silica particle (refractive index: 1.46), an alumina particle (refractive index: 1.63), a zirconia particle, a titania particle, and a particle having hollows or pores.

Among those, a crosslinked poly((meth)acrylate) particle and a crosslinked poly(acryl-styrene) particle are preferably used, and by adjusting the refractive index of a binder according to the refractive index of each light-transmitting particle selected from these particles, it is possible to achieve a surface unevenness, a surface haze, an internal haze and a total haze suitable for the hard coat layer of the optical film in the present invention.

The average particle diameter of the light-transmitting particle is preferably 1.0 μm to 12 μm, more preferably 3.0 μm to 12 μm, still more preferably 4.0 μm to 10.0 μm, and most preferably 4.5 μm to 8 μm. By setting the refractive index difference and the particle size to the range above, the distribution of a scattered light angle does not extend to a wide angle, and blurring of characters or contrast reduction on the display is unlikely caused. Since it is unnecessary to increase the film thickness of a layer to which the particle is added and a problem, such as curling or a cost rise, hardly occurs, the particle diameter is preferably 12 μm or less. Furthermore, a particle diameter limited to the above-described range is preferred in that the amount coated at the time of coating can be reduced, the drying is completed fast, and a planar defect such as drying unevenness scarcely occurs.

As a method for measuring the average particle diameter of a light-transmitting particle, any measurement method may be applied as long as it measures the average particle diameter of particles. Preferably, however, 100 particles are observed by observing particles through a transmission electron microscope (magnification rate: 500,000 to 2,000,000 times) and the average value thereof may be used as an average particle diameter.

The shape of a light-transmitting particle is not particularly limited, but a spherical shape particle may also be used in combination with a light-transmitting particle having a different shape, such as an irregularly shaped particle (e.g., non-spherical particle). In particular, if the short axis of a non-spherical particle is aligned in the normal direction of a hard coat layer, it is possible to use a particle having a smaller particle diameter than a spherical particle.

The light-transmitting particle is preferably blended to be contained in an amount of 0.1% by mass to 40% by mass, more preferably 1% by mass to 30% by mass, and still more preferably 1% by mass to 20% by mass in the total solid content of a hard coat layer. By setting the blending ratio of the light-transmitting particle to the range above, it is possible to control the internal haze such that it falls within a preferred range.

(Viscosity Agent)

In order to adjust the viscosity of the hard coat layer forming composition (the coating liquid), a viscosity agent may be used.

The viscosity agent as used herein means a substance capable of increasing the viscosity of a liquid when it is added.

In addition, known viscosity adjusting agents or thixotropic imparting agents, for example, layered compounds such as smectite, mica, bentonite, silica, and montmorillonite, and sodium polyacrylate described in Japanese Patent Laid-Open Publication No. H8-325491, and ethyl cellulose, polyacrylic acid, and organic clay described in Japanese Patent Laid-Open Publication No. H10-219136, may be used. As the thixotropic imparting agent, a compound obtained by organically modifying a layered compound having a particle diameter of 0.3 μm or less is particularly preferred, and a particle diameter of 0.1 μm or less is more preferred. The particle diameter of the layered compound may be regarded as the length of a longitudinal axis. Usually, approximately 1 to 10 parts by mass per 100 parts by mass of the UV-curable resin is appropriate.

(Photopolymerization Initiator)

It is preferred to introduce a photopolymerization initiator into the hard coat layer forming composition. The photopolymerization initiator described in relation to the low-moisture permeable layer may also be preferably used in the hard coat layer forming composition.

The photopolymerization initiator in the hard coat layer forming composition is contained in an amount that is large enough to polymerize a polymerizable compound contained in the hard coat layer forming composition while being small enough to prevent the starting point from being overly increased. For this reason, the content of the photo polymerization initiator in the hard coat layer forming composition is preferably 0.5% by mass to 8% by mass, and more preferably 1% by mass to 5% by mass, based on the total solid content in the hard coat layer forming composition.

(UV Absorber)

The polarizing plate of the present invention may be used in a liquid crystal display device member. From the viewpoint of preventing deterioration of the polarizing plate or the liquid crystal cell, the polarizing plate having a hard coat layer may be given a UV absorbent property by containing a UV absorber in the hard coat layer to the extent that UV curing is not inhibited.

(Solvent)

In the present invention, the hard coat layer forming composition may contain a solvent. As a solvent, different types of solvent may be used in consideration of the solubility of monomers, the dispersibility of light-transmitting particles, the drying property at the time of coating, and the like. Examples of such an organic solvent may include dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanot, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methyleyelohexane, ethylcyclohexane, benzene, toluene, and xylene, which may be used either alone or in combination of two or more thereof.

In the present invention, the solvent is preferably used such that the solid content concentration of the hard coat layer forming composition ranges from 20% by mass to 80% by mass, more preferably from 30% by mass to 75% by mass, and still more preferably from 40% by mass to 70% by mass.

{Functional Layer}

In the present invention, a functional layer may be further formed on the surface of the polarizing plate. The functional layer is not particularly limited to specific types, but includes an antireflective layer (a layer in which the refractive index is adjusted, such as a low refractive index layer, a medium refractive index layer, and a high refractive index layer), an antiglare layer, an antistatic layer, a UV absorbing layer, and an antifouling layer.

One of these functional layers may be provided, or two or more thereof may be provided. A method of stacking the functional layer is not particularly limited.

The functional layer may be laminated on a surface, on which the low-moisture permeable layer is not laminated.

[Optically Anisotropic Layer]

In the present invention, an optically anisotropic layer may also be provided on one surface of the polarizing plate. The optically anisotropic layer may be an optically anisotropic layer where a film having a constant phase difference is formed uniformly in plane, or an optically anisotropic layer patterned such that phase difference regions having different slow axis directions or different phase difference values are regularly arranged in plane.

As described above, the phase difference of the present invention is preferably arranged on the surface of the liquid crystal display device.

When the polarizing plate of the present invention has both of a hard coat layer and an optically anisotropic layer, the optically anisotropic layer is preferably formed through a transparent support on a surface where the hard coat layer is not laminated.

The materials and manufacturing conditions of the optically anisotropic layer may be selected according to its use, but in the present invention, an optically anisotropie layer using a polymerizable liquid crystalline compound is preferred. In this case, it is also a preferred embodiment in which an alignment film is formed between the optically anisotropic layer and the transparent support such that the alignment film is in contact with the optically anisotropic layer.

Preferred examples of a film having an optically anisotropic layer formed uniformly in plane may include an embodiment in which an optically anisotropic layer is a λ/4 film, and this embodiment is particularly useful as a member of an active-type 3D liquid crystal display device. An embodiment that has a λ/4 film as an optically anisotropic layer and a hard coat layer, which are laminated on opposite surfaces through a transparent support, is described in Japanese Patent Laid-Open Publication No. 2012-098721 and Japanese Patent Laid-Open Publication No. 2012-127982, and such an embodiment may be preferably used in the liquid crystal display device having the polarizing plate of the present invention.

Meanwhile, preferred examples of an optically anisotropic layer having formed therein a pattern may include a pattern-type λ/4 film, and embodiments described in Japanese Patent No. 4825934 and Japanese Patent No. 4887463 may be preferably used in the liquid crystal display device having the polarizing plate of the present invention.

In addition, an embodiment described in Japanese National Publication of International Patent Application No. 2012-517024 (WO2010/090429), in which a photo-alignment film and patternwise exposure are combined, may also be preferably used in the liquid crystal display device having the polarizing plate of the present invention.

[Layer Configuration of Optical Film Having Optically Anisotropic Layer]

In the present invention, preferred layer configurations of the optical film having an optically anisotropic layer formed on the surface of the polarizing plate will he described in the following.

Optically Anisotropic Layer/Transparent Support/Polarizer/Low-Moisture Permeable Layer/Hard Coat Layer

Optically Anisotropic Layer/Transparent Support/Polarizer/Adhesion Layer/Low-Moisture Permeable Layer/Hard Coat Layer

Optically Anisotropic Layer/Transparent Support/Polarizer/Low-Moisture Permeable Layer/Hard Coat Layer/Antireflective Layer

Optically Anisotropic Layer/Transparent Support/Polarizer/Adhesion Layer/Low-Moisture Permeable Layer/Hard Coat Layer/Antireflective Layer

In the case of having an optically anisotropic layer, the optically anisotropic layer is preferably formed of a liquid crystalline compound having a curable group such as unsaturated polymerizable group, and an alignment film is preferably formed under a liquid crystal layer. In the present invention, it is also preferred that the alignment film is formed of a curable composition containing a radical polymerizable compound.

[Manufacturing Method of Polarizing Plate]

The polarizing plate of the present invention may be manufactured by a general method. For example, in an aspect in which the transparent support is formed of a cellulose acylate film (a cellulose acylate-based polymer layer), the polarizing plate may be manufactured by bonding the cellulose acylate film and the polarizer. The bonding surface of the cellulose acylate film is preferably subjected to an alkali saponification. Further, an aqueous solution of a fully saponified polyvinyl alcohol may be used for the bonding.

The polarizer may be available from those prepared by a conventionally known method. For example, use may be made on those formed by treating a film formed of a hydrophilic polymer such as ethylene-modified polyvinyl alcohol, in which the content of the polyvinyl alcohol or ethylene units is 1 mol % to 4 mol %, the degree of polymerization is 2,000 to 4,0000, and the degree of saponification is 99.0 inol.% to 99.99 mol %, with a dichroic dye such as iodine and stretching the film, or by treating a plastic film such as vinyl chloride and orienting the film.

Further, as a method of obtaining a polarizer fim of 10 μm or less by stretching or staining the fim in a state of a laminated film in which a polyvinyl alcohol layer is formed on a substrate, those described in Japanese Patent No. 5048120, Japanese Patent No. 5143918, Japanese Patent No. 5048120, Japanese Patent No. 4691205, Japanese Patent No. 4751481, and Japanese Patent No. 4751486 may be exemplified, and a known technique for the polarizers may be preferably used in the polarizing plate of the present invention.

The low-moisture permeable layer is laminated on a surface opposite to the transparent support of the thus-obtained polarizer directly or through an adhesive.

The polarizing plate of the present invention is preferably formed with transparent support/polarizer/low-moisture permeable layer/hard coat layer in this order, or transparent support/polarizer/adhesive layer/low-moisture permeable layer/hard coat layer in this order to be adjacent to each other.

[Liquid Crystal Display Device]

The liquid crystal display device of the present invention is characterized by including a liquid crystal cell and the polarizing plate of the present invention disposed on a viewing side of the liquid crystal cell, in which a low-moisture permeable layer of the polarizing plate is disposed at the viewing side.

(Configuration of General Liquid Crystal Display Device)

The liquid crystal display device has a configuration in which a liquid crystal cell is provided by carrying a liquid crystal between two electrode substrates, two polarizing plates are disposed on both sides thereof, and if necessary, at least one optically-compensatory film is disposed between the liquid crystal cell and the polarizing plate.

The liquid crystal layer of the liquid crystal cell is usually formed by encapsulating a liquid crystal in a space formed by interposing a spacer between two substrates. A transparent electrode layer is formed, on a substrate, as a transparent film containing a conductive substance. In the liquid crystal cell, a gas barrier layer, a hard coat layer or an undercoat layer (used for adhesion of the transparent electrode layer) may be further provided. These layers are usually provided on the substrate. The substrate of the liquid crystal cell generally has a thickness of 50 μm to 2 mm.

The liquid crystal display device is generally provided with a substrate including a liquid crystal cell between two polarizing plates. However, the polarizing plate of the present invention is used as a polarizing plate disposed at the viewing side of the liquid crystal cell, among the two polarizing plates, and the polarizing plate is disposed such that the low-moisture permeable layer becomes a viewing side.

Also preferred is an embodiment in which after the polarizing plate protective film of the present invention, is disposed such that the low-moisture permeable layer of a viewing-side polarizing plate out of the two polarizing plates becomes a viewing side, the polarizing plate protective film of the present invention is further disposed for a backlight-side protective film of a backlight-side polarizing plate, thereby suppressing the expansion and shrinkage of polarizers contained in the two polarizing plates and preventing the warpage of a panel.

(Types of Liquid Crystal Display Device)

The film of the present invention can be used in different modes of a liquid crystal cell. Different display modes such as TN (Twisted Nematic), IPS (In-Plane Switching), FLC (Fenoelectric Liquid Crystal), AFLC (Anti-Ferroelectric Liquid Crystal), OCB (Optically Compensatory Bend), STN (Super Twisted Nematic), VA (Vertically Aligned), ECB (Electrically Controlled Birefringence), and HAN (Hybrid Aligned Nematic) have been proposed. Furthermore, display modes obtained by alignment division of the display modes above have also been proposed. The polarizing plate protective film of the present invention is effective in a liquid crystal display device in any display mode, and is also effective in any of a transmission type, a reflection type and a transflective type liquid crystal display device.

### EXAMPLES

Hereinafter, the present invention will be described in more detail below with reference to Examples. Materials, reagents, amounts and ratios of substances, operations, or the like described in the following. Examples can be appropriately changed or modified without departing from the purport of the present invention. Accordingly, the present invention is not limited to the Examples.

[Preparation of Low-Moisture Permeable Layer Forming Composition]

The low-moisture permeable layer was prepared as follows.

(Composition of Low-Moisture Permeable Layer 1 Forming Composition)

| | |
|---|---|
| A-DCP (tricyclodecane dimethanol diacrylate) | 77.0 parts by mass |
| (manufactured by Shin Nakamura Chemical | |
| Co., Ltd.) | |
| Unsaturated Acid-Modified Rosin A | 20.0 parts by mass |
| (Acid Number: 342 mgKOH/g) | |
| Irgacure 907 | 3.0 parts by mass |
| SP-13 | 0.04 parts by mass |
| Compound A | 2.0 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 1 Forming Composition was 55% by mass.

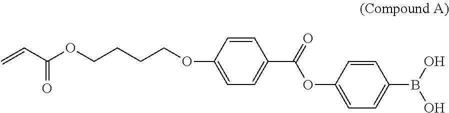 [SMILES: C=CC(=O)OCCCCOc1ccc(C(=O)Oc2ccc(B(O)O)cc2)cc1]

SP-13 (a leveling agent having the following structure. In the following formula, the composition ratio of 60:40 is a molar ratio)

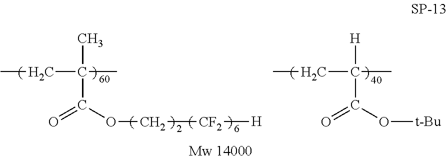

(Manufacture of Unsaturated Acid-Modified Rosin A)

In a sealable reactor vessel equipped with a stirrer, a reflux condenser, a nitrogen intake tube, 3,000 g of an unrefined gum rosin made in China (having an acid number of 171 mgKOH/g, a softening point of 74° C., and a color tone of 6G) was introduced and distilled under a reduced pressure of 400 Pa while purging with nitrogen to finally obtain a main residue having an acid value of 176.3 mgKOH/g, a softening point of 80.5° C. and a color (Gardner) of 2 (a yield rate of 86.3%) as a refined gum rosin R. The resin acid number was measured according to a method defined in JIS K-5601. Also, the softening point was measured by the ring and ball softening method defined in JIS K-2531.

In a reactor vessel equipped with a stirrer, a reflux condenser having a water distributor, and a thermometer, 1,000 parts by mass of the refined gum rosin R manufactured as described above was introduced and agitated under a nitrogen atmosphere with elevating the temperature to 180° C. to result in a melt. Then, 267 parts by mass of a fumaric acid was introduced and agitated with elevating the temperature to 230° C., and after being kept at the elevated temperature for 1 hour, was cooled to obtain a solid resin of an unsaturated acid-modified rosin A. The resin acid number was 342.0 mgKOH/g and the softening point was 125° C.

(Composition of Low-Moisture Permeable Layer 2 Forming Composition)

| | |
|---|---|
| A-DCP | 82.0 parts by mass |
| Unsaturated Acid-Modified Rosin A | 15.0 parts by mass |
| (Acid Number: 342 mgKOH/g) | |
| Irgacure 907 | 3.0 parts by mass |
| SP-13 | 0.04 parts by mass |
| Compound A | 2.0 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 2 Forming Composition was 55% by mass.

(Composition of Low-Moisture Permeable Layer 3 Forming Composition)

| | |
|---|---|
| A-DCP | 97.0 parts by mass |
| Irgacure 907 | 3.0 parts by mass |
| SP-13 | 0.04 parts by mass |
| Compound A | 2.0 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 3 Forming Composition was 55% by mass.

(Composition of Low-Moisture Permeable Layer 4 Forming Composition)

| | |
|---|---|
| Monomer A1 | 82.0 parts by mass |
| Unsaturated Acid-Modified Rosin A | 15.0 parts by mass |
| (Acid Number: 342 mgKOH/g) | |
| Irgacure 907 | 3.0 parts by mass |
| SP-13 | 0.04 parts by mass |
| Compound A | 2.0 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 4 Forming Composition was 55% by mass.

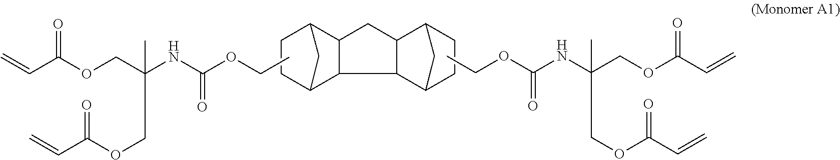

(Composition of Low-Moisture Permeable Layer 5 Forming Composition)

| | |
|---|---|
| Monomer B | 82.0 parts by mass |
| Unsaturated Acid-Modified Rosin A | 15.0 parts by mass |
| (Acid Number: 342 mgKOH/g) | |
| Irgacure 907 | 3.0 parts by mass |
| SP-13 | 0.04 parts by mass |
| Compound A | 2.0 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 5 Forming Composition was 55% by mass.

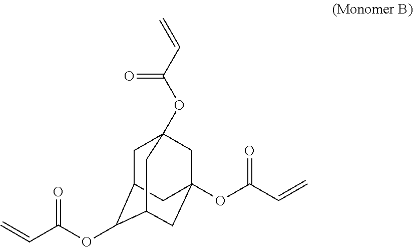 [SMILES: C=CC(=O)OC1C2CC3(OC(=O)C=C)CC1CC(OC(=O)C=C)(C2)C3]

(Composition of Low-Moisture Permeable Layer 2 Forming Composition)

| | |
|---|---|
| A-DCP | 77.0 parts by mass |
| Unsaturated Acid-Modified Rosin B | 20.0 parts by mass |
| (Acid Number: 315 mgKOH/g) | |
| Irgacure 907 | 3.0 parts by mass |
| SP-13 | 0.04 parts by mass |
| Compound A | 2.0 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 6 Forming Composition was 55% by mass.

(Manufacture of Unsaturated Acid-Modified Rosin B)

With reference to Preparation Example 3 disclosed in Japanese Patent Laid-Open Publication No. 2007-111735 and by using the above-described refined gum rosin R and a maleic acid, a maleic acid-modified rosin was synthesized. The resin acid number was 315 mgKOH/g and the softening point was 155° C.

(Composition of Low-Moisture Permeable Layer 7 Forming Composition)

| | |
|---|---|
| A-DCP | 77.0 parts by mass |
| Unsaturated Acid-Modified Rosin C | 20.0 parts by mass |
| (Acid Number: 241 mgKOH/g) | |
| Irgacure 907 | 3.0 parts by mass |
| SP-13 | 0.04 parts by mass |
| Compound A | 2.0 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 7 Forming Composition was 55% by mass.

(Manufacture of Unsaturated Acid-Modified Rosin C)

With reference to Preparation Example 2 disclosed in Japanese Patent Laid-Open Publication No. 2007-111735 and by using the above-described refined gum rosin R and an acrylic acid, an acrylic acid-modified rosin was synthesized. The resin acid number was 241 mgKOH/g and the softening point was 130° C.

(Composition of Low-Moisture Permeable Layer 7 Forming Composition)

| | |
|---|---|
| A-DCP | 77.0 parts by mass |
| Unsaturated Acid-Modified Rosin A | 20.0 parts by mass |
| (Acid Number: 342 mgKOH/g) | |
| Irgacure 907 | 3.0 parts by mass |
| SP-13 | 0.04 parts by mass |
| Compound A | 2.0 parts by mass |
| UV agent A | 20.5 parts by mass |
| MEK (methyl ethyl ketone) | 24.5 parts by mass |
| MIBK (methyl isobutyl ketone) | 57.3 parts by mass |

The solid concentration of Low-Moisture Permeable Layer 8 Forming Composition was 55% by mass.

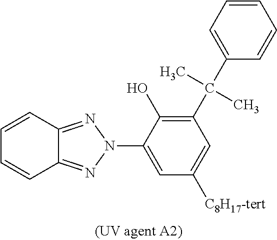

<Manufacture of Film 1>

(1) Preparation of Cellulose Acylate Resin by Synthesis

A cellulose acylate having an acetyl substitution degree of 2.88 was prepared. As a catalyst, sulfuric acid (7.8 parts by mass based on 100 parts by mass of cellulose) was added, and acetic acid was added to udergo an acylation reaction at 40° C. Then, the sulfuric acid catalyst amount, moisture amount, and aging time were adjusted to prepare the total substitution degree and the 6-position substitution degree. The acetyl substitution degree of the cellulose acylate was determined by ¹³C-NMR according to the method described in Carbohydr. Res. 273 (1995) 83-91 (Tezuka et. al.). The aging was conducted at a temperature of 40° C. Further, low molecular weight components of the cellulose acylate were washed off with acetone.

(2) Preparation of Cellulose Acylate Solution A-2

The following composition was introduced into a mixing tank, stirred to dissolve each component, additionally heated at 90° C. for about 10 minutes, and then, filered by a filter paper having an average pore diameter of 34 μm and a sintered metal filter having an average pore diameter of 10 μm.

Cellulose Acylate Solution A-2

| | |
|---|---|
| Cellulose Acylate having an acetyl substitution | 100.0 parts by mass |
| degree of 2.88 | |
| The following plasticizer | 15 parts by mass |
| (polycondensation ester of carboxylic acid and diol) | |
| Methylene chloride | 451.0 parts by mass |
| Methanol | 39.0 parts by mass |

(Plasticizer)

Polycondesation ester of adipic acid as dicarboxylic acid, and ethylene glycol and 1,2-propylene glycol as diol (adipic acid:ethylene glycol:1,2-propylene glycol=100:70:30 (by mass))

(Terminal: acetyl group, Hydroxyl number: 112 mgKOH/g, Molecular weight: 1000)

[Preparation of Matting Agent Dispersion]

Subsequently, the following composition containing Cellulose Acylate Solution A-2 prepared by the above-described method was introduced into a disperser to prepare a matting agent dispersion.

Matting Agent Dispersion

| | |
|---|---|
| Matting agent (AEROSIL R972) | 0.2 parts by mass |
| Methylene chloride | 72.4 parts by mass |
| Methanol | 10.8 parts by mass |
| Cellulose Acylate Solution A-2 | 10.3 parts by mass |

[Preparation of Cellulose Acylate Solution A-3]

Cellulose Acylate Solution A-3 was prepared by mixing 100 parts by mass of Cellulose Acylate Solution A-2 and the matting agent dispersion in such an amount that the amount of inorganic particles is 0.20 parts by mass based on the cellulose acylate resin.

(3) Cast

Cellulose Acylate Solution A-3 was cast using a band caster.

(4) Dry

A web (film) obtained from the case was peeled off from the band, and then, dried within a tenter device that conveys by clipping both ends of the web with clips, at 100° C. for 20 minutes. Then, the web was further dried by being conveyed in a dry zone at a dry temperature of 120° C. Meanwhile, the dry temperature as used herein refers to a film surface temperature.

(5) Winding

After cooled to room temperature, each film was wound to prepare a roll having a roll width of 1,340 mm and a roll length of 2,600 mm, thereby obtaining Film 1 having a film thickness of 34 μm.

[Preparation of Core Layer Cellulose Acylate Solution]

The following composition was introduced into a mixing tank, and stirred to dissolve each component, thereby preparing a cellulose acetate solution.

Composition of Core Layer Cellulose Acylate Solution

| | | |
|---|---|---|
| Cellulose acylate having an acetyl substitution degree | 100 | parts by mass |
| of 2.88 | | |
| Ester oligomer (Plasticizer 1 below) | 10 | parts by mass |
| Polarizer durability improving agent | 4 | parts by mass |
| (Compound A3 below) | | |
| UV absorber (the above UV agent A2) | 4 | parts by mass |
| Methylene chloride (first solvent) | 438 | parts by mass |
| Methanol (second solvent) | 65 | parts by mass |

(Plasticizer 1) 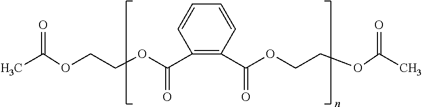
Molecular weight 1000
(Compound A3)

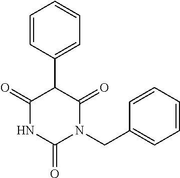 [SMILES: O=C1NC(=O)N(Cc2ccccc2)C(=O)C1c1ccccc1]

[Preparation of Outer Layer Cellulose Acylate Solution]

To 90 parts by mass of the above-described core layer cellulose acylate solution was added 10 parts by mass of the following matting agent solution to prepare an outer layer cellulose acetate solution.

Composition of Matting Agent

| | |
|---|---|
| Silica particles having an average particle | 2 parts by mass |
| size of 20 nm (AEROSIL R972, manufactured by | |
| Nippon Aerosil Co., Ltd.) | |
| Methylene chloride (first solvent) | 76 parts by mass |
| Methanol (second solvent) | 11 parts by mass |
| Core layer cellulose acylate solution | 1 part by mass |

[Manufacture of Cellulose Acylate Film]

The core layer cellulose acylate solution and the outer cellulose acylate solutions on both sides thereof were cast simultaneously in three layers on a 25° C. drum from a casting port. The east film was peeled off in a state of a solvent content of about 20% by mass. Both ends of the film in the width direction were fixed by tenter clips, and the film was dried while stretching 1.1 times in the transverse direction, in a state where a residual solvent was 3% by mass to 15% by mass. Then, the film was conveyed between rolls of a heat treatment apparatus to manufacture Film 2 having a film thickness of 25 μm.

<Manufacture of Film 3>

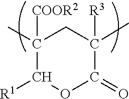

Pellets of a mixture (Tg 127° C.) of 90 parts by mass of a (meth)acrylic resin having a lactone ring structure, in which in the formula, R¹ is a hydrogen atom, and R² and R³ are methyl groups [copolymerizable monomer mass ratio=methyl methacrylate/methyl 2-(hydroxymethyl)acrylate=8/2, a Iactone ring formation rate: about 100%, a content ratio of the lactone structre: 19.4%, a weight average molecular weight: 133,000, a melt flow rate: 6.5 g/10 min (240° C., 10 kgf), Tg: 131° C.}, and 10 parts by mass of a acrylonitrile-styrene (AS) resin (TOYO AS AS20, manufactured by TOYO STYRENE Co., Ltd.) were supplied to a twin screw extruder, and melted and extruded in a sheet form at about 280° C. to thereby obtain a 40-μm thick sheet of (meth)acrylic polymer having a lactone structure. The unstretched sheet was stretched 1.3 timses longitudinally and 1.3 times transversely at a temperauter of 160° C. to obtain Film 3 having a thickness of 25 μm.

<Manufacture of Film 4>

In a 30-L reaction vessel equipped with a stirrer, a temperature sensor, a condenser tube, and a nitrogen intake tube, 41.5 parts by mass of methyl methacrylate (MMA), 6 parts by mass of methyl 2-(hydroxymethyl)acrylate (MHMA), 2.5 parts by mass of 2-[2′-hydroxy-(5′-methacryloyloxy)ethylphenyl]-2H-benzotriazole (Trade Name: RUVA-93, manufactured by Otsuka Chemical Co., Ltd.), 50 parts by mass of toluene as a polymerization solvent, 0.025 parts by mass of an antioxidant (ADEKA STAB 2112, manufactured by Asahi Denka Kogyo K.K.), and 0.025 parts of n-dodecyl mercaptan as a chain transfer agent were introduced. Then, the temperature of the mixture was elevated to 105° C. while being supplied with nitrogen.

When a reflux started as a result of elevating the temperature, 0.05 parts by mass of t-amylperoxyisononanoate (Trade Name: Luperox 570, manufactured by Arkema Yoshitomi, Ltd.) was added as a polymerization initiator and simultaneously 0.10 parts by mass of t-amylperoxyisononanoate was added dropwise over 3 hours to allow solution polymerization to progress under a reflux having a temperature of approximately 105 to 110° C., further followed by 4 hours of aging.

Subsequently, to the obtained polymer solution, 0.05 parts by mass of 2-ethylhexyl phosphate (Phoslex A-8, manufactured by Sakai Chemical Industry Co., Ltd.) was added as a catalyst for cyclocondensation (cyclization catalyst). Then, under a reflux having a temperature of approximately 90° C. to 110° C. for 2 hours, the mixture was subjected to a cyclocondensation reaction. The resulting polymer solution was heated in an autoclave at 240° C. for 30 minutes and was further subjected to a cyclocondensation reaction. Subsequently, 0.94 parts by mass of CGL 777MPA (manufactured by BASF) as a UV absorber was added to the polymer solution after the reaction.

Subsequently, the obtained polymer solution was introduced into a vent type twin-screw extruder (Φ=50.0 mm, L/D=30) equipped with 1 rear vent and 4 fore vents (the first, second, third, and fourth vents from the upstream side) and equipped at its rear end with a leaf disk-type polymer filter (with a filtration accuracy of 5μ and a filtration area of 1.5 m²) at a processing rate of 45 kg/h in terms of the amount of resin, wherein the extruder has a barrel temperature of 240° C., a revolution rate of 100 rpm, and a reduced pressure level of 13.3 to 400 hPa (10 to 300 mmHg) to perform devolatilization. During this process, a separately prepared mixed solution of an antioxidanticyclization catalyst deactivator was added at a rate of 0.68 kg/h on the downstream side of the first vent, and ion-exchanged water was added at a rate of 0.22 kg/h on the downstream side of the third vent.

As the mixed solution of the antioxidanticyclization catalyst deactivator, a solution in which 50 parts by mass of an antioxidant (SUMILIZER GS manufactured by Sumitomo Chemical Co., Ltd.) and 35 parts by mass of zinc octylate (NIKKA OCTHIX 3.6% manufactured by NIHON KAGAKU SANGYO CO., LTD.) were dissolved in 200 parts by mass of toluene, was used.

Subsequently, after the devolatilization was completed, the thermally molten resin that remained in the extruder was extruded from a distal end of the extruder while simultaneously filtered by a polymer filter and then pelletized by a pelletizer. Thus, an acrylic resin having a lactone ring structure in its main chain and a pellet having a transparent resin composition having a UV absorber were obtained. The weight average molecular weight of the resin was 145,000 and the glass transition temperature Tg of the resin and the resin composition was 122° C.

The above-manufactured pellet having a resin composition containing an acrylic resin having a lactone ring structure on its main chain and a UV absorber was melted and extruded from a coat hanger type T-die to thereby manufacture an acrtkuc polymer film having a thickness of approximately 30 μm. This film was used as Film 4.

<Manufacture of Film 5>

Pellets of a norbornene-based resin (ZEONOR 1060, manufactured by NIPPON ZEON Co., Ltd.), which were dried at 100° C. for 5 hours, were used to obtain Film 5 that is a cycloolefin-based polymer having a film thickness of 20 μm, by extrusion.

<Manufacture of Film 6>

[Preparation of Cellulose Ester Solution for Air Layer]

The following composition was introduced into a mixing tank, and stirred while heating to dissolve each component, thereby preparing a cellulose ester solution for an air layer.

Composition of Cellulose Ester Solution for Air Layer

| Cellulose ester (cetyl substitution degree: 2.86) | 100 | parts by mass |
|---|---|---|
| Sugar ester compound of Formula (R-I) | 3 | parts by mass |
| Sugar ester compound of Formula (R-II) | 1 | part by mass |
| UV absorber below | 2.4 | parts by mass |
| Silica particles (average particle size: 16 nm) | 0.026 | parts by mass |
| (AEROSIL R972, manufactured by Nippon | | |
| Aerosil Co., Ltd.) | | |
| Methylene chloride | 339 | parts by mass |
| Methanol | 74 | parts by mass |
| Butanol | 3 | parts by mass |

Formula (R-1) 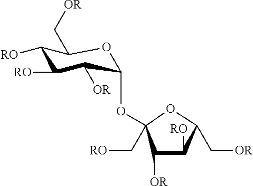 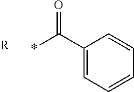 [SMILES: *C(=O)c1ccccc1]
Formula (R-11) 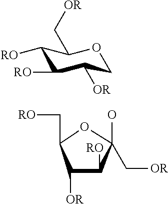
R = Acetate/I-Butylate (2/8)
UV absorber

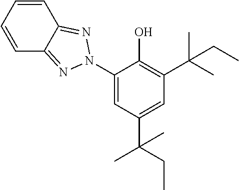 [SMILES: CCC(C)(C)c1cc(-n2nc3ccccc3n2)c(O)c(C(C)(C)CC)c1]

[Preparation of Cellulose Ester Solution for Drum Layer]

The following composition was introduced into a mixing tank, and stirred while heating to dissolve each component, thereby preparing a cellulose ester solution for a drum layer.

Composition of Cellulose Ester Solution for Drum Layer

| | | |
|---|---|---|
| Cellulose ester (acetyl substitution degree: 2.86) | 100 | parts by mass |
| Sugar ester compound of Formula (R-I) | 3 | parts by mass |
| Sugar ester compound of Formula (R-II) | 1 | part by mass |
| UV absorber above | 2.4 | parts by mass |
| Silica particles (average particle size: 16 nm) | 0.091 | parts by mass |
| (AEROSIL R972, manufactured by | | |
| Nippon Aerosil Co., Ltd.) | | |
| Methylene chloride | 339 | parts by mass |
| Methanol | 74 | parts by mass |
| Butanol | 3 | parts by mass |

[Preparation of Cellulose Ester Solution for Core Layer]

The following composition was introduced into a mixing tank, and stirred while heating to dissolve each component, thereby preparing a cellulose ester solution for a care layer.

Composition of Cellulose Ester Solution for Core Layer

| | | |
|---|---|---|
| Cellulose ester (acetyl substitution degree: 2.86) | 100 | parts by mass |
| Sugar ester compound of Formula (R-I) | 8.3 | parts by mass |
| Sugar ester compound of Formula (R-II) | 2.8 | part by mass |
| UV absorber above | 2.4 | parts by mass |
| Methylene chloride | 266 | parts by mass |
| Methanol | 58 | parts by mass |
| Butanol | 2.6 | parts by mass |

[Film Formation by Co-Casting]

As a casting die, an apparatus equipt with a feed block adjusted for co-casting was used to form a three-layered film. The cellulose ester solution for air layer, the cellulose ester solution for core layer, and the cellulose ester solution for drum layer wer co-cast from a casting prot onto a drum that was cooled to −7° C. At this time, the flow rates of the resepctive solutions were adjusted such that the ratio of thickness becomes air layer/core layer/drum layer=7/90/3.

On a specular stainless steel support that was a drum having a diameter of 3 m, casting was performed to be drum layer/core layer/air layer from the stainless steep support side. A dry air at 34° C. was blown onto the drum at 270 m³/min.

Then, in 50 cm befor the end portion of the casting portion, the cellulose ester film which has been rotated in eating was peeled off from the drum, and then, both ends thereof was clipped with pin tenters. When peeling off, 5% stretching was performed in the conveyance direction (length direction).

The cellulose ester web held by the pin tenters was conveyed to a dry zone. Drying was first performed with a dry air at 45° C., and then, at 110° C. for 5 minutes. At this time, the cellulose ester web was conveyed while being stretched by 10% in the width direction.

After the web was left from the pin tenters, the portion held by the pin tenters was sequentially cut, and an unevenness of 10 μm in height and 15 mm in width was formed in the both end of the web in the width direction.

At this time, the width of the web was 1,610 mm. Drying was performed at 140° C. for 10 minutes while applying the addition of tensile stress of 210 N in the conveyance direction. Further, the end portions in the width direction were sequentially cut such that the web has a desired width, thereby manufacturing Film 6 having a film thickness of 41 μm. At this time, the film thickness of the end portions in the width directcion cut after drying at 140° C. was the same as that of the central portion of the web.

[Preparation of Hard Coat Layer Forming Composition]

The composition was prepared as follows.

(Composition of Hard Coat Layer 1 Forming Composition)

| | |
|---|---|
| Smectite | 1.00 part by mass |
| (Lucentite STN, manufactured by | |
| CO-OP Chemical Co., Ltd) | |
| Crosslinked acryl-styrene particles | 8.00 parts by mass |
| (average particle diameter: 2.5 μm, | |
| refractive index: 1.52) | |
| Acrylate monomer | 87.85 parts by mass |
| (NK Ester A9550, manufactured by Shin | |
| Nakamura Chemical Co., Ltd.) | |
| Irgacure 907 | 3.00 parts by mass |
| Leveling agent (SP-13) | 0.15 parts by mass |
| MIBK (methyl isobutyl ketone) | 133.50 parts by mass |
| MEK (methyl ethyl ketone) | 16.0 parts by mass |

The solid concentration of the hard coat layer 1 forming composition was 40% by mass. Meanwhile, the resin particles and the smectite were added in a dispersed state.

(Composition of Hard Coat Layer 2 Forming Composition)

| | |
|---|---|
| PET-30 | 97.0 part by mass |
| (mixture of pentaerythritol triacrylate/pentaerythritol | |
| tetraacrylate, manufactured by | |
| NIPPON KAYAKU Co., Ltd) | |
| Irgacure 907 | 3.00 parts by mass |
| SP-13 | 0.04 parts by mass |
| MEK (methyl ethyl ketone) | 81.8 parts by mass |

<Manufacture of Polarizing Plate 1>

{Manufacture of Polarizer}

Iodine was absorbed onto each stretched polyvinyl alcohol film having a film thickness of 30 μm, 15 μm, or 8 μm to thereby manufacture a polarizer having a film thickness of 30 μm, 15 μm, or 8 μm respectively.

{Manufacure of Polarizing Plate Using Bonding Method A}

A corona treatment was perform on the surface of Film 1. Subsequently, the polarizer having a film thickness of 15 μm was bonded to Film 1 using a polyvinyl alcohol-based adhesive, and dried at 70° C. for 10 minutes or more to thereby manufacture a one-sided Polarizing Plate 1. Here, the transmission axis of the polarizer and the conveyance direction of the film were disposed so as to be orthogonal to each other.

On the polarizer side of the one-sided polarizing plate 1, the low-moisture permeable layer forming composition was coated by a die coating method using the slot die described in Example 1 of Japanese Patent Laid-Open Publication No. 2006-122889 under the condition of a conveying speed of 30 m/min, and dried at 60° C. for 150 seconds. Then, the coated layer was cured by irradiating with an ultraviolet ray at an illuminance of 400 mW/cm² and an irradiation dose of 120 ml/cm² by using an air-cooled metal halide lamp with an output of 160 W/cm (manufactured by Eye Graphics Co., Ltd.) at an oxygen concentration of about 0.1 vol. % while further purging with nitrogen, and was wound. The coated amount was adjusted such that the film thickness of the low-moisture permeable layer reached 30 μm.

On the low-moisture permeable layer, the hard coat layer 1 forming composition was coated by a die coating method using the slot die described in Example 1 of Japanese Patent Laid-Open Publication No. 2006-122889 under the condition of a conveying speed of 30 m/min, and dried at 60° C. for 150 seconds. Then, the coated layer was cured by irradiating with an ultraviolet ray at an illuminance of 400 mW/cm² and an irradiation dose of 300 mJ/cm² by using an air-cooled metal halide lamp with an output of 160 W/cm (manufactured by Eye Graphics Co., Ltd.) at an oxygen concentration of about 0.1 vol. % while further purging with nitrogen, and was wound. The coated amount was adjusted such that the film thickness of the hard coat layer 1 reached 6 μm.

<Manufacture of Polarizing Plate 16>

{Manufacure of Polarizing Plate Using Bonding Method B}

<Adhesive for Polarizing Plate>

An adhesive for a polarizing plate was prepared by mixing 100 parts by mass of 2-hydroxyethyl acrylate, 10 parts by mass of tolylele diisocyanate, and 3 parts by mass of a photopolymerization initiator (Irgacure 127, manufactured by BASF).

A corona treatment was perforne on the surface of Film 3. Subsequently, the adhesive for a polarizing plate was coated onto Film 3 using a microgravure coater (gravure roll: #300, rotation speed 140%/line speed) such that the thickness was 3 μm, thereby manufacturing a film provided with an adhesive. Subsequently, the polarizer having a film thickness of 15 μm was bonded to Film 3 provided with the adhesive. From the bonded film, a one-sided polarizing plate 16 having a transparent support on one side of the polarizer was obtained by irradiating UV rays. The line speed was set to 20 m/min, and the light quantity of the ultraviolet rays was set to 300 mJ/cm². Here, the transmission axis of the polarizer and the conveyance direction of the film were disposed so as to be orthogonal to each other.

<Manufacture of Polarizing Plates 2 to 12, 15, 17 to 26, 28 to 32, and 35 to 37>

The transparent support, the low-moisture permeable layer, and the hard coat layer were selected from those listed in the following table. The polarizer was used as in the following table by selecting from those having a film thickness of 30 μm, 15 μm, or 8 μm. The method of bonding the polarizer and the transparent support was used as in the following table by selecting from the bonding method A or B.

<Manufacture of Low-Moisture Permeable Layer 9 and Polarizing Plate 13>

Low-moisture permeable layer 9 and Polarizing plate 13 were manufactured in the same manner as in Polarizing plate 1, except the UV irradiation dose when curing the coating layer in the manufacture of Polarizing plate 1 was changed to 200 mJ/cm².

<Manufacture of Low-Moisture Permeable Layer 10 and Polarizing Plate 14>

Low-moisture permeable layer 10 and Polarizing plate 14 were manufactured in the same manner as in Polarizing plate 1, except the oxygen concentration when curing the coating layer in the manufacture of Polarizing plate 1 was changed to about 0.1 vol %.

<Manufacture of Polarizing Plate 27>

[Manufacture of Low-Moisture Permeable Film for Transfer]

On the film 3 of which the surface was subjetedc to the corona treatment, the low-moisture permeable layer forming composition was coated by a die coating method using the slot die described in Example 1 of Japanese Patent Laid-Open Publication No. 2006-122889 under the condition of a conveying speed of 30 m/min, and dried at 60° C. for 150 seconds. Then, the coated layer was cured by irradiating with an ultraviolet ray at an illuminance of 400 mW/cm² and an irradiation dose of 120 mJ/cm² by using an air-cooled metal halide lamp with an output of 160 W/cm (manufactured by Eye Graphics Co., Ltd.) at an oxygen concentration of about 0.1 vol. % while further purging with nitrogen, and was wound. The coated amount was adjusted such that the film thickness of the low-moisture permeable layer reached 30 μm, thereby manufacturing a low-moisture permeable film for transfer.

[Manufature of Polarizing Plate by Transfer]

The adhesive for a polarizing plate was coated onto the polarizer side of the one-sided polarizing plate 1 using a microgravure coater (gravure roll: #300, rotation speed 140%/line speed) such that the thickness was 3 μm, thereby manufacturing a film provided with an adhesive. Subsequently, the low-moisture permeable layer 1 side of the low-moisture permeable film for transfer was bonded thereto. From the bonded film. Polarizing plate 27 having the low-moistrure permeable layer 1 on the polarizer side of the one-sided polarizing plate 1 was obtained by irradiating UV rays and peeling off Film 3. The line speed was set to 20 ml/min, and the light quantity of the ultraviolet rays was set to 300 mJ/cm². Here, the transmission axis of the polarizer and the conveyance direction of the film were disposed so as to be orthogonal to each other.

The polarizing plate, the hard coat layer, the low-moisture permeable layer, the polarizer, the transparent support, and the film thickness used are listed in Table 1 below.

TABLE 1

| | Configuration of Polarizing Plate | | | | | | | | Thickness |
|---|---|---|---|---|---|---|---|---|---|
| | | | Low-Moisture | | | Transparent | | | of |
| | Polarizing | | Permeable Layer | | Polarizer | Support | | | Polarizing |
| | Plate | Hard | | Thickness | Thickness | | Thickness | Bonding | Plate |
| | No. | Coat | | [μm] | [μm] | Kind | [μm] | Method | [μm] |
| Ex. 1 | Polarizing | Hard | Low- | 30 | 15 | Film | 34 | A | 79 |
| | Plate 1 | Coat | Moisture | | | 1 | | | |
| | | 1 | Permeable | | | | | | |
| | | | Layer 1 | | | | | | |
| Ex. 2 | Polarizing | Hard | Low- | 15 | 15 | Film | 34 | A | 64 |
| | Plate 2 | Coat | Moisture | | | 1 | | | |
| | | 1 | Permeable | | | | | | |
| | | | Layer 1 | | | | | | |
| Ex. 3 | Polarizing | Hard | Low- | 8 | 15 | Film | 34 | A | 57 |
| | Plate 3 | Coat | Moisture | | | 1 | | | |
| | | 1 | Permeable | | | | | | |
| | | | Layer 1 | | | | | | |
| Ex. 4 | Polarizing | Hard | Low- | 30 | 15 | Film | 34 | A | 79 |
| | Plate 4 | Coat | Moisture | | | 1 | | | |
| | | 1 | Permeable | | | | | | |
| | | | Layer 2 | | | | | | |
| Ex. 5 | Polarizing | Hard | Low- | 15 | 15 | Film | .34 | A | 64 |
| | Plate 5 | Coat | Moisture | | | 1 | | | |
| | | 1 | Permeable | | | | | | |
| | | | Layer 2 | | | | | | |
| Ex. 6 | Polarizing | Hard | Low- | 7 | 15 | Film | 34 | A | 56 |
| | Plate 6 | Coat | Moisture | | | 1 | | | |
| | | 1 | Permeable | | | | | | |
| | | | Layer 2 | | | | | | |
| Ex. 7 | Polarizing | Hard | Low- | 30 | 15 | Film | 34 | A | 79 |
| | Plate 7 | Coat | Moisture | | | 1 | | | |
| | | 1 | Permeable | | | | | | |
| | | | Layer 3 | | | | | | |
| Ex. 8 | Polarizing | Hard | Low- | 15 | 15 | Film | 34 | A | 64 |
| | Plate 8 | Coat | Moisture | | | 1 | | | |
| | | 1 | Permeable | | | | | | |
| | | | Layer 3 | | | | | | |
| Ex. 9 | Polarizing | Hard | Low- | 30 | 15 | Film | 34 | A | 79 |
| | Plate 9 | Coat | Moisture | | | 1 | | | |
| | | 1 | Permeable | | | | | | |
| | | | Layer 4 | | | | | | |
| Ex. 10 | Polarizing | Hard | Low- | 30 | 15 | Film | 34 | A | 79 |
| | Plate 10 | Coat | Moisture | | | 1 | | | |
| | | 1 | Permeable | | | | | | |
| | | | Layer 5 | | | | | | |
| Ex. 11 | Polarizing | Hard | Low- | 30 | 15 | Film | 34 | A | 79 |
| | Plate 11 | Coat | Moisture | | | 1 | | | |
| | | 1 | Permeable | | | | | | |
| | | | Layer 6 | | | | | | |
| Ex. 12 | Polarizing | Hard | Low- | 30 | 15 | Film | 34 | A | 79 |
| | Plate 12 | Coat | Moisture | | | 1 | | | |
| | | 1 | Permeable | | | | | | |
| | | | Layer 7 | | | | | | |
| Ex. 13 | Polarizing | Hard | Low- | 30 | 15 | Film | 34 | A | 79 |
| | Plate 13 | Coat | Moisture | | | 1 | | | |
| | | 1 | Permeable | | | | | | |
| | | | Layer 9 | | | | | | |
| Ex. 14 | Polarizing | Hard | Low- | 30 | 15 | Film | 34 | A | 79 |
| | Plate 14 | Coat | Moisture | | | 1 | | | |
| | | 1 | Permeable | | | | | | |
| | | | Layer 10 | | | | | | |
| Ex. 15 | Polarizing | Hard | Low- | 30 | 15 | Film | 25 | A | 70 |
| | Plate 15 | Coat | Moisture | | | 2 | | | |
| | | 1 | Permeable | | | | | | |
| | | | Layer 2 | | | | | | |
| Ex. 16 | Polarizing | Hard | Low- | 30 | 15 | Film | 25 | B | 80 |
| | Plate 16 | Coat | Moisture | | | 3 | | | |
| | | 1 | Permeable | | | | | | |
| | | | Layer 2 | | | | | | |
| Ex. 17 | Polarizing | Hard | Low- | 30 | 15 | Film | 20 | B | 75 |
| | Plate 17 | Coat | Moisture | | | 5 | | | |
| | | 1 | Permeable | | | | | | |
| | | | Layer 2 | | | | | | |
| Ex. 18 | Polarizing | Hard | Low- | 30 | 8 | Film | 34 | A | 72 |
| | Plate 18 | Coat | Moisture | | | 1 | | | |
| | | 1 | Permeable | | | | | | |
| | | | Layer 1 | | | | | | |
| Ex. 19 | Polarizing | Hard | Low- | 15 | 8 | Film | 34 | A | 57 |
| | Plate 19 | Coat | Moisture | | | 1 | | | |
| | | 1 | Permeable | | | | | | |
| | | | Layer 1 | | | | | | |
| Ex. 20 | Polarizing | Hard | Low- | 30 | 8 | Film | 34 | A | 72 |
| | Plate 20 | Coat | Moisture | | | 1 | | | |
| | | 1 | Permeable | | | | | | |
| | | | Layer 2 | | | | | | |
| Ex. 21 | Polarizing | Hard | Low- | 15 | 8 | Film | 34 | A | 57 |
| | Plate 21 | Coat | Moisture | | | 1 | | | |
| | | 1 | Permeable | | | | | | |
| | | | Layer 2 | | | | | | |
| Ex. 22 | Polarizing | Hard | Low- | 30 | 8 | Film | 25 | B | 73 |
| | Plate 22 | Coat | Moisture | | | 3 | | | |
| | | 1 | Permeable | | | | | | |
| | | | Layer 2 | | | | | | |
| Ex. 23 | Polarizing | Hard | Low- | 30 | 8 | Film | 20 | B | 68 |
| | Plate 23 | Coat | Moisture | | | 5 | | | |
| | | 1 | Permeable | | | | | | |
| | | | Layer 2 | | | | | | |
| Ex. 24 | Polarizing | Hard | Low- | 30 | 15 | Film | 41 | A | 86 |
| | Plate 24 | Coat | Moisture | | | 6 | | | |
| | | 1 | Permeable | | | | | | |
| | | | Layer 1 | | | | | | |
| Ex. 25 | Polarizing | Hard | Low- | 15 | 15 | Film | 41 | A | 71 |
| | Plate 25 | Coat | Moisture | | | 6 | | | |
| | | 1 | Permeable | | | | | | |
| | | | Layer 1 | | | | | | |
| Ex. 26 | Polarizing | Hard | Low- | 30 | 15 | Film | 34 | A | 79 |
| | Plate 26 | Coat | Moisture | | | 1 | | | |
| | | 1 | Permeable | | | | | | |
| | | | Layer 8 | | | | | | |
| Ex. 27 | Polarizing | Hard | Low- | 30 | 15 | Film | 34 | A | 79 |
| | Plate 27 | Coat | Moisture | | | 1 | | | |
| | | 1 | Permeable | | | | | | |
| | | | Layer 1 | | | | | | |
| | | | (Tansfer) | | | | | | |
| Ex. 28 | Polarizing | Hard | Low- | 30 | 15 | Film | 34 | A | 79 |
| | Plate 28 | Coat | Moisture | | | 1 | | | |
| | | 2 | Permeable | | | | | | |
| | | | Layer 2 | | | | | | |
| C. Ex. 1 | Polarizing | Hard | Film 5 | 20 | 15 | Film | 34 | A | 69 |
| | Plate 29 | Coat | | | | 1 | | | |
| | | 1 | | | | | | | |
| C. Ex. 2 | Polarizing | Hard | Film 4 | 30 | 15 | Film | 34 | A | 79 |
| | Plate 30 | Coat | | | | 1 | | | |
| | | 1 | | | | | | | |
| C. Ex. 3 | Polarizing | Hard | Low- | 5 | 15 | Film | 34 | A | 54 |
| | Plate 31 | Coat | Moisture | | | 1 | | | |
| | | 1 | Permeable | | | | | | |
| | | | Layer 2 | | | | | | |
| C. Ex. 4 | Polarizing | Hard | Low- | 40 | 15 | Film | 34 | A | 89 |
| | Plate 32 | Coat | Moisture | | | 1 | | | |
| | | 1 | Permeable | | | | | | |
| | | | Layer 2 | | | | | | |
| C. Ex. 5 | Polarizing | Hard | Film 4 | 30 | 8 | Film | 34 | A | 72 |
| | Plate 35 | Coat | | | | 1 | | | |
| | | 1 | | | | | | | |
| C. Ex. 6 | Polarizing | Hard | Low- | 5 | 8 | Film | 34 | A | 47 |
| | Plate 36 | Coat | Moisture | | | 1 | | | |
| | | 1 | Permeable | | | | | | |
| | | | Layer 2 | | | | | | |
| C. Ex. 7 | Polarizing | Hard | Low- | 5 | 30 | Film | 34 | A | 69 |
| | Plate 37 | Coat | Moisture | | | 1 | | | |
| | | 1 | Permeable | | | | | | |
| | | | Layer 2 | | | | | | |

For the polarizing plates manufactured above, various characteristics were determined by the following methods.

(1) Evaluation of Moisture-Heat Durability of Polarizer

As for the polarizers of the respective examples, comparative examples, and reference examples manufactured above, an orthogonal transmittance CT at a wavelength of 550 nm was measured using UV 3150 (manufactured by SHIMADZU SEISAKUSHO Ltd.)

Polarizing plates, of which the humidity was adjusted for 240 hours under environment of 25° C. and a relative humidity of 60%, were prepared. Subsequently, two samples (about 5 cm×5 cm) were fabricated by attaching the polarizing plate to a glass via an adhesive such that a film provided with a hard coat layer (transparent support) becomes the outside, and then, a transmittance was measusred in a state of being attached that the absorption axes of the two samples are orthogonal to each other. This transmittance was regarded as an orthogonal transmittance before the heat resistance test.

Then, an orthogonal transmittance after the heat resistance test was measured in the same manner after storage for 100 hours under dry environment (a state where the humidity was not adjusted; the relative humidity was 0% to 15% in the inventive examples and comparative examples), at 100° C. A change in orthogonal transmittance befor and after the lapse of time was determined, and the polarizer heat resistance was evaluated by the following criteria. Meanwhile, the result was listed in Table 2 below.

Here, the change in orthogonal transmittance is calculated by the following equation.

Change in orthogonal transmittance (%)={(Orthogonal transmittance (%) after heat resistance test−Orthogonal transmittance (%) befrore heat resistance test

A: The change in orthogonal transmittance is less than 0.05%

B: The change in orthogonal transmittance is 0.05% or triore and less than 0.07%

C: The change in orthogonal transmittance is 0.07% or more and less than 0.09%

D: The change in orthogonal transmittance is 0.09% or more and less than 0.11%

E: The change in orthogonal transmittance is 0.11% or more

(2) Evaluation of Adhesion

As for the polarizers of the respective examples, comparative examples, and reference examples manufactured above, the surface of the polarizing plate where the hard coat layer is provided was incised with a cutter knife to form 11 vertical lines and 11 horizontal lines in a grid pattern and thus define a total of 100 squares, and an adhesion test was performed by press-bonding a polyester adhesive tape “No. 31B” manufactured by Nitto Denko Corp. to observe the presence or absence of separation with eyes.

When the separation was present in less than 20 of the 100 squares, the adhesion test was repeated up to 2 times on the same site, and the presence or absence of separation was observed with eyes to perform a 5-step evaluation described below.

A: No separation was recognized in the 100 blocks during the two times of adhesion testing

B: Separation was observed in 1 to 5 blocks of the 100 blocks during the two times of adhesion testing

C: Separation was observed in 6 to 19 blocks of the 100 blocks during the two times of adhesion testing

D: Separation was observed in more than 20 blocks of the 100 blocks during the two times of adhesion testing

E: Separation was observed in more than 20 blocks of the 100 blocks during the one time of adhesion testing

(3) Evaluation of Brittleness

As for the polarizers of the respective examples, comparative examples, and reference examples manufactured above, the polarizing plate was wound on a 6-mmΦ cylindrical bar such that the surface where the hard coat layer is provided was disposed outside, according to JIS K 5600-5-1, and cracks on the hard coat layer was visually observed.

OK: No crack was observed

NG: Cracks were observe

(4) Evaluation of Display Unevenness

A commercially available liquid crystal display television to slim 42 type liquid crystal display device of IPS mode, Δnd=320 nm) was regarded as Liquid crystal display device A. Polarizing plates were removed from both sides of the liquid crystal cell. As a result, the thickness of the glass used was about 500 μm, and the thickness of the liquid crystal cell was about 1,000 μm.

In addition, iPad manufactured by Apple Inc. (a liquid crystal display device of IPS mode, Δnd=350 nm) was regarded as Liquid crystal display device B. Polarizing plates were removed from both sides of the liquid crystal cell. As a result, the thickness of the glass used was about 300 μm, and the thickness of the liquid crystal cell was about 600 μm.

Using the two kinds of liquid crystal display devices, the polarizing plate manufactured in Table 1 was bonded to the liquid crystal cell through an adhesive. Here, the outside (viewing side) of the liquid crystal cell was bonded with a polarizing plate having the hard coat layer such that the transparent support became the liquid crystal cell side, and the rear surface thereof was bonded with a polarizing plate having no hard coat layer such that the transparent support became the liquid crystal cell side. Then, evaluation was performed.

After maintaining for 72 hours under envrionment of 50° C. and a relative humidity of 85%, and followed by being left to stand for 2 hours under envrionment of 25° C. and a relative humidity of 60%, a backlight of the liquid crystal display was turned on for 10 hours, and then, the light leakage on the four corners of the panel was evaluated to thereby evaluate display unevenness.

By imaging a black display screen from the front side of the screen using a brightness measuring camera “ProMetric” (manufactured by Radiant Imaging Inc.), the light leakage was evaluated based on the average brightness of the entire screen and a brightness difference of a portion where the light leakage on the four corners was large, by the following criteria. The result is shown in Table 2 below.

A: No light leakage was visually recognized on the four corners of the liquid crystal display device (the light leakage of the panel is approximately the same as that before thermo-on)

B slight amount of light leakage was visually recognized on one corner of the liquid crystal display device, which was allowable

C slight amount of light leakage was visually recognized on two or four corners of the liquid crystal display device, which was not allowable

D large amount of light leakage was visually recognized on at least one corner of the liquid crystal display device, which was not allowable

TABLE 2

| | | Evaluation Result | | | | | |
|---|---|---|---|---|---|---|---|
| | | Moisture | | | | | |
| | | Permeability | | Adhesion | Brittleness | Display | Display |
| | | of Low- | | of | of | Unevenness | Unevenness |
| | | Moisture | Moisture-Heat | Hard Coat | Hard Coat | Pannel A | Pannel B |
| | | Permeable | Durability of | Layer | Layer | Cell | Cell |
| | Polarizing | Layer | Polarizer | (Cross | (Mandrel | Thickness = | Thickness = |
| | Plate No. | [g/m²/day] | [Δtransmittance] | Cut Test) | Test) | 1,000 μm | 600 μm |
| Ex. 1 | Polarizing | 19 | A | A | OK | A | A |
| | Plate 1 | | | | | | |
| Ex. 2 | Polarizing | 41 | A | A | OK | A | A |
| | Plate 2 | | | | | | |
| Ex. 3 | Polarizing | 74 | A | A | OK | A | B |
| | Plate 3 | | | | | | |
| Ex. 4 | Polarizing | 24 | A | A | OK | A | A |
| | Plate 4 | | | | | | |
| Ex. 5 | Polarizing | 49 | A | A | OK | A | A |
| | Plate 5 | | | | | | |
| Ex. 6 | Polarizing | 98 | A | A | OK | A | B |
| | Plate 6 | | | | | | |
| Ex. 7 | Polarizing | 44 | A | A | OK | A | A |
| | Plate 7 | | | | | | |
| Ex. 8 | Polarizing | 87 | A | A | OK | A | B |
| | Plate 8 | | | | | | |
| Ex. 9 | Polarizing | 41 | A | A | OK | A | A |
| | Plate 9 | | | | | | |
| Ex. 10 | Polarizing | 45 | A | A | OK | A | A |
| | Plate 10 | | | | | | |
| Ex. 11 | Polarizing | 31 | A | A | OK | A | A |
| | Plate 11 | | | | | | |
| Ex. 12 | Polarizing | 45 | A | A | OK | A | A |
| | Plate 12 | | | | | | |
| Ex. 13 | Polarizing | 21 | A | B | OK | A | A |
| | Plate 13 | | | | | | |
| Ex. 14 | Polarizing | 20 | A | B | OK | A | A |
| | Plate 14 | | | | | | |
| Ex. 15 | Polarizing | 24 | A | A | OK | A | B |
| | Plate 15 | | | | | | |
| Ex. 16 | Polarizing | 24 | A | A | OK | A | A |
| | Plate 16 | | | | | | |
| Ex. 17 | Polarizing | 24 | A | A | OK | A | A |
| | Plate 17 | | | | | | |
| Ex. 18 | Polarizing | 19 | A | A | OK | A | A |
| | Plate 18 | | | | | | |
| Ex. 19 | Polarizing | 41 | C | A | OK | A | A |
| | Plate 19 | | | | | | |
| Ex. 20 | Polarizing | 24 | B | A | OK | A | A |
| | Plate 20 | | | | | | |
| Ex. 21 | Polarizing | 49 | C | A | OK | A | A |
| | Plate 21 | | | | | | |
| Ex. 22 | Polarizing | 19 | A | A | OK | A | A |
| | Plate 22 | | | | | | |
| Ex. 23 | Polarizing | 19 | A | A | OK | A | A |
| | Plate 23 | | | | | | |
| Ex. 24 | Polarizing | 17 | A | A | OK | A | A |
| | Plate 24 | | | | | | |
| Ex. 25 | Polarizing | 37 | A | A | OK | A | B |
| | Plate 25 | | | | | | |
| Ex. 26 | Polarizing | 22 | A | A | OK | A | A |
| | Plate 26 | | | | | | |
| Ex. 27 | Polarizing | 19 | A | A | OK | A | A |
| | Plate 27 | | | | | | |
| Ex. 28 | Polarizing | 24 | A | A | OK | A | A |
| | Plate 28 | | | | | | |
| C. Ex. 1 | Polarizing | 6 | A | D | OK | A | A |
| | Plate 29 | | | | | | |
| C. Ex. 2 | Polarizing | 108 | D | A | OK | B | C |
| | Plate 30 | | | | | | |
| C. Ex. 3 | Polarizing | 140 | D | A | OK | C | D |
| | Plate 31 | | | | | | |
| C. Ex. 4 | Polarizing | 16 | A | A | NG | A | A |
| | Plate 32 | | | | | | |
| C. Ex. 5 | Polarizing | 108 | E | A | OK | B | C |
| | Plate 35 | | | | | | |
| C. Ex. 6 | Polarizing | 140 | E | A | OK | C | D |
| | Plate 36 | | | | | | |
| C. Ex. 7 | Polarizing | 140 | A | A | OK | C | D |
| | Plate 37 | | | | | | |

As shown in Tables 1 and 2 above, in Example Nos. 1 to 28, since the layer configuration, and the characteristics of the polarizer and the low-moisture permeable layer are within the range of the present invention, the moisture permeability is low, and the polarizer heat durability, the adhesion of the hard coat layer, and the brittleness of the hard coat layer are excellent. Even when incorpoated into the liquid crystal display device, it is possible to suppress generation of the display unevenness.

On the other hand, in Comparative Example 1, since a film composed of a cycloolefin-based polymer is used as a low-moisture permeable layer, the adhesion with the hard coat layer is deteriorated. In Compartive Examples 2 and 5, since a film coposed of an acrylic polymer is used as a low-moisture permeable layer, the moisture permeability of the low-moisture permeable layer is increased, the durability of the polarizer is decreased, and the display unevenness of the liquid crystal display device is deteriorated.

In Comparative Examples 3, 6, and 7, since the film thickness of the low-moisture permeable layer is 5 μm, the display unevenness of the liquid crystal display device is deteriorated.

In Comparative Example 4, since the thickness of the low-moisture permeable layer exceeds the range of the present ivnetion, the brittleness of the hard coat layer is deteriorated.

Further, in Examples 16 and 17, since acrylic polymer and cycloolefin polymer was used for the transparent support, even in a case where the unevenness easily occurs and a very thin pannel B was used, it was possible to suppress generation of the unevenness.

What is claimed is:

1. A polarizing plate comprising a transparent support, a polarizer, and a low-moisture permeable layer in this order,
wherein a thickness of the polarizer is 15 μm or less,
a film thickness of the low-moisture permeable layer is greater than 5 μm and 30 μm or less,
the low-moisture permeable layer is formed from a composition containing at least one of a compound having a cyclic aliphatic hydrocarbon group and two or more ethylenically unsaturated double bond groups in its molecule, and a compound having a fluorene ring and two or more ethylenically unsaturated double bond group in its molecule, and a polymerization initiator, and
the polarizer and the low-moisture permeable layer are laminated directly or through an adhesive layer.

2. The polarizing plate of claim 1, wherein a hard coat layer is provided on a surface opposite to the polarizer of the low-moisture permeable layer.

3. The polarizing plate of claim 1, wherein the cyclic aliphatic hydrocarbon group is a group represented by the following Formula (I): 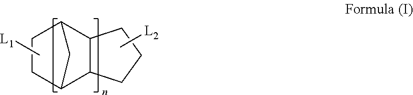
wherein L₁ and L₂ each independently represent a single bond or di- or higher-valent group, and
n represents an integer of 1 to 3.

4. The polarizing plate of claim 1, wherein the composition contains a rosin compound.

5. The polarizing plate of claim 1, wherein the transparent support contains a polymer selected from a cellulose acylate-based polymer, a polyester-based polymer, a (meth)acrylic polymer, and a cycloolefin-based polymer in an amount of 50% by mass or more in the transparent support.

6. The polarizing plate of claim 1, wherein a thickness of the transparent support is 35 μm.

7. The polarizing plate of claim 1, wherein a thickness of the polarizing plate is 80 μm or less.

8. The polarizing plate of claim 1, wherein the low-moisture permeable layer has an ultraviolet absorbability.

9. A liquid crystal display device comprising:
a liquid crystal cell; and
the polarizing plate of claim 1 which is disposed at a viewing side of the liquid crystal cell,
wherein the low-moisture permeable layer of the polarizing plate is arranged at the viewing side.
